(19) United States
(12) Patent Application Publication
(10) Pub. No.: US 2014/0124616 A1
(43) Pub. Date: May 8, 2014

(54) AEROSTAT DEPLOYMENT SYSTEM AND METHODS FOR THE SAME

(71) Applicants: Michael Alan Greco, Sioux Falls, SD (US); Eric Jon Baack, Crooks, SD (US); Patrick Adam Thies, Sioux Falls, SD (US); Bradley Roger Jensen, Beresford, SD (US); Justin Lee Marsh, Sioux Falls, SD (US); Frank Louis Raymond, III, Sioux Falls, SD (US)

(72) Inventors: Michael Alan Greco, Sioux Falls, SD (US); Eric Jon Baack, Crooks, SD (US); Patrick Adam Thies, Sioux Falls, SD (US); Bradley Roger Jensen, Beresford, SD (US); Justin Lee Marsh, Sioux Falls, SD (US); Frank Louis Raymond, III, Sioux Falls, SD (US)

(21) Appl. No.: 13/795,158

(22) Filed: Mar. 12, 2013

Related U.S. Application Data
(60) Provisional application No. 61/722,020, filed on Nov. 2, 2012.

(51) Int. Cl. B64B 1/40

(52) U.S. Cl. CPC B64B 1/40
USPC 244/31; 29/428

(57) ABSTRACT

An aerostat deployment system includes fore and aft envelope housings with respective folded fore and aft portions of an inflatable aerostat envelope therein. A support frame is interposed between the fore and aft envelope housings, and a payload is coupled with the inflatable aerostat envelope between the fore and aft envelope housings at the time of deployment inflation. One or more of the fore or aft envelope housings includes a brake configured to control unrolling of the folded fore or aft portions. In one example, the folded aft portion of the inflatable aerostat envelope including a tail portion is inflated prior to inflation of the folded fore portion.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc.; Sioux Falls, S. Dak. All Rights Reserved.

### TECHNICAL FIELD

This document pertains generally, but not by way of limitation, to deployment of aerostat inflatable envelopes.

### BACKGROUND

Aerostats include aircraft that remain aloft with lighter than air gasses, such as helium. In at least some examples, aerostats include inflatable envelopes that allow the suspension of various payloads above the ground. For instance, some example aerostats suspend instrument packages having one or more of optical, infrared, communication capabilities hundreds or even thousands of feet above the ground.

The inflation of an envelope large enough to carry payloads creates a number of issues. In one example, an envelope configured to carry the payload may be thousands of cubic feet in volume and accordingly require a significant amount of time to inflate, for instance 1 hour or more. A partially (or fully) inflated aerostat at this size is difficult to control with a ground crew of a few individuals during inflation, especially in high winds of 20 knots or more. Additionally, if the wrong portion of the envelope inflates first, such as the nose, the envelope may present an aerodynamic profile that is even harder to control. Moreover, the payload is mounted after inflation in some examples and accordingly requires extensive control and anchoring to maintain the inflated aerostat in a stationary position for mounting of the payload.

Alternatively, the envelope is rapidly inflated for a corresponding fast deployment. Rapid inflation, for instance with Helium delivered at a significant flow rate (such as 3,000 cfm), increases the skin stress on localized portions of the envelope and can rip or damage the envelope fabric.

In other examples, the components needed to inflate and deploy an aerostat are transported in multiple vehicles or containers that are assembled at the deployment site. These components include the inflatable envelope, a source of lighter than air gas, a gas coupling configured to connect the source of gas with the inflatable envelope, tethers, and the payload. The assembly of these components at the deployment site adds additional time and labor before deployment of the aerostat is achieved. Additionally, the separate components may require multiple transportation resources including trucks, trailers, and the like.

### OVERVIEW

The present inventors have recognized, among other things, that a problem to be solved can include the controlled deployment of an aerostat envelope that ensures the aerostat is reliably and rapidly deployed even in inclement weather, while at the same time minimizing skin stresses of the envelope. In an example, the present subject matter can provide a solution to this problem with the provision of an aerostat deployment system that includes the aerostat envelope in a folded configuration and able to deploy in a controlled manner. In one example, the aerostat deployment system controls the inflation of the aerostat envelope by retaining a fore portion of the envelope within a fore envelope housing while an aft portion including a tail portion is first inflated (at least partially). The inflation of the tail portion provides an aerodynamic profile for the envelope in partially inflated conditions, such as by allowing the partially inflated envelope to turn into the wind and accordingly mitigate undesirable rotation or whipping of the envelope during deployment.

Further, because the fore and aft portions of the envelope are housed in respective fore and aft housings, the aerostat payload may be coupled with the envelope prior to deployment, for instance between the housings. Accordingly, during deployment, the payload is already coupled with the envelope, and difficult post deployment installation of the payload (e.g., in inclement weather, high winds, and the like) is avoided. Moreover, overall deployment time of the envelope is minimized through preinstallation of the payload. In one example, the envelope is inflated in a ready-to-use configuration in around 15 minutes or less from the time of initial set up to full inflation of the aerostat. Further still, all of the components of the aerostat deployment system are provided in a solitary unit or are easily coupled with the remainder of the deployment system to allow transportation of the system in as few vehicles as possible (e.g., a single trailer) and rapid initial set up followed by immediate deployment of the envelope.

In another example, the aerostat deployment system controls the deployment of the folded envelope from one or both of the fore and aft envelope housings during inflation. For instance, the pressure within the envelope is monitored throughout inflation with a pressure sensor coupled with a programmed logic controller (PLC). The PLC cooperates with one or more brakes (e.g., disk brakes, pinch rollers, and the like), pinch rollers, and the like to meter out the folded envelope according to the pressure within the envelope as the envelope is inflated. In one example, the envelope is gradually fed from one or both of the fore and aft envelope housings as pressure rises within the envelope during inflation. The gradual feeding out of the envelope ensures that the pressure does not rise to a sufficient level that may cause damaging skin stress in the envelope fabric (e.g., above 6 inches of water column (IWC)).

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a side view of one example of an aerostat envelope in an inflated configuration and coupled with an aerostat deployment system.

FIG. 2A is a perspective view of one example of an aerostat deployment system with an aerostat envelope in a stored configuration.

FIG. 2B is a perspective view of the aerostat deployment system of FIG. 2A without the aerostat envelope.

FIG. 3 is a side view of one example of an envelope housing of the aerostat deployment system.

FIG. 4 is a cross sectional view of one example of an envelope housing of the aerostat deployment system.

FIG. 5A is a perspective view of one example of a spindle and a brake coupled with the spindle.

FIG. 5B is a perspective view of the spindle of FIG. 5A with a pinch roller.

FIG. 6 is a perspective view of one example of a payload and gondola.

FIG. 7 is a perspective view of one example of an inflation port and pliable gas diffuser.

FIG. 8 is a perspective view of one example of an automated quick disconnect feature configured to couple a gas source with the inflation port of the aerostat envelope.

FIG. 9 is a plan view of one example of an uninflated aerostat envelope in an initial configuration.

FIG. 10A is a plan view of a hull of the aerostat envelope of FIG. 9 in a folded core configuration with the hull folded into left and right cores.

FIG. 10B is a cross sectional view of the aerostat envelope of FIG. 10A taken along line 10B-10B showing the left and right cores.

FIG. 11A is a rear view of a tail portion of the aerostat envelope of FIG. 1 in a deployed configuration.

FIG. 11B is a schematic view of the tail portion including fin reefing patches of FIG. 10A based on a cross section taken along line 11B-11B in an intermediate folded configuration with fins laid over top of each other.

FIG. 11C is a plan view of a fin reefing patch configured for coupling between fins.

FIG. 11D is a perspective view of the fin folding sequence as viewed from the leading edge of the fins looking towards the tail.

FIG. 11E is a cross-sectional view of the folded fins of FIG. 11D taken along line 11E-11E.

FIG. 12A is a perspective view of one example of a tail sleeve with an opened seam.

FIG. 12B is a perspective view of the tail sleeve of FIG. 12A with the seam closed.

FIG. 13 is a perspective view of the aerostat envelope of FIG. 10A with the tail sleeve positioned around the tail portion.

FIG. 14A is a perspective view of the aerostat envelope of FIG. 10A with the aerostat envelope inverted and the fore spindle at the nose portion of the aerostat envelope.

FIG. 14B is a perspective view of the aerostat envelope of FIG. 10A with the aerostat envelope inverted and the aft spindle at the tail portion of the aerostat envelope.

FIG. 15 is a perspective view of the aerostat envelope with the folded fore and aft portions wrapped around the respective fore and aft spindles.

FIG. 16 is a side view of the aerostat envelope in a first partially inflated configuration with the aft portion partially inflated.

FIG. 17 is a side view of the aerostat envelope in a second partially inflated configuration including the tail portion as the tail sleeve unrolls fore to aft from the envelope.

FIG. 18 is a side view of the aerostat envelope in a third partially inflated configuration with the fore portion partially inflated.

FIG. 19 is a block diagram showing one example of a method for deploying an aerostat with the aerostat deployment system.

FIG. 20 is a schematic view of one example of a control and instrument system for the aerostat deployment system.

FIG. 21 is a block diagram showing one example of a method for controlling deployment of an aerostat with the control and instrument system.

### DETAILED DESCRIPTION

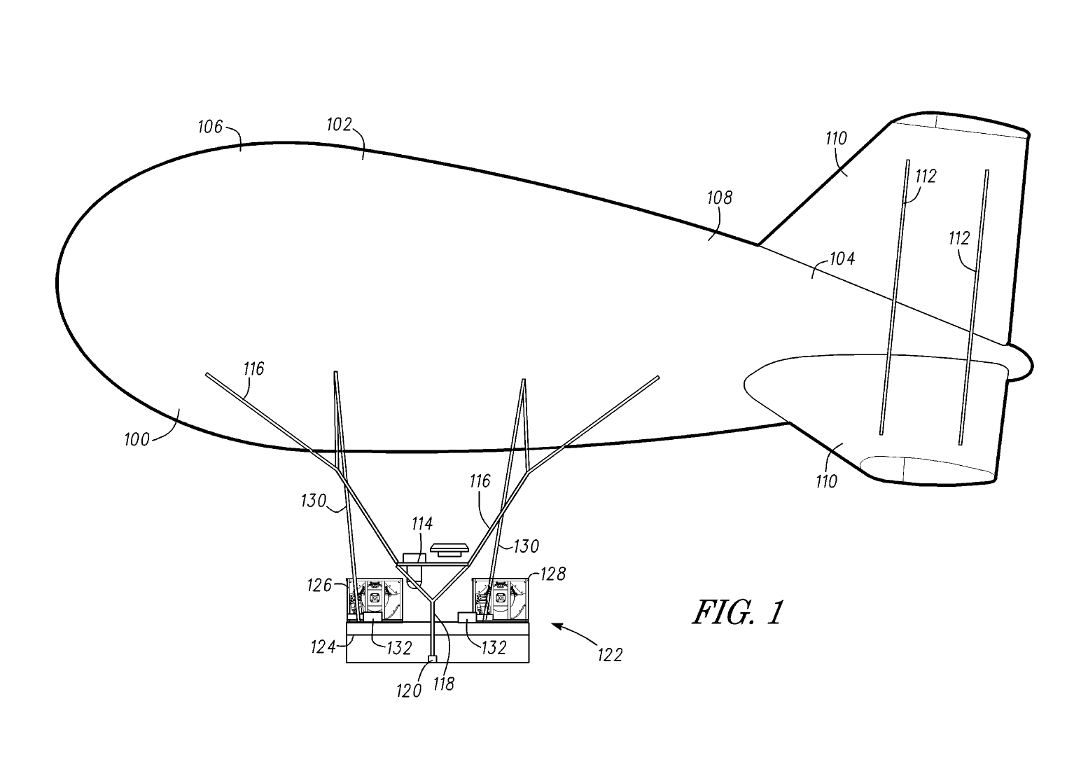

FIG. 1 shows one example of an aerostat envelope in a fully deployed (inflated) configuration. As shown in FIG. 1, the aerostat envelope 100 includes a hull 102 and a tail portion 104 coupled with the hull 102. As further shown in FIG. 1, the hull 102 includes a fore portion 106 and an aft position 108 adjacent to the tail portion 104. The tail portion 104, in one example, includes one or more fins 110 arranged around the tail portion 104. In another example, the fins 110 are positioned relative to one another, for instance, constrained from relative movement with the use of guide lines 112 deployed between each of the fins 110 (e.g., from fin reefing patches).

FIG. 1 further shows an aerostat deployment system 122 coupled with the fully inflated aerostat envelope 100. As shown, the aerostat deployment system 122 is coupled with the aerostat envelope 100 by way of one or more control lines 130 extending from the envelope 100 to a support frame 124. In one example, the control lines 130 are received within tension winches 132 that substantially constrain movement of the aerostat envelope 100 from the aerostat deployment system 122 until release of the aerostat envelope 100 is desired relative to the deployment system 122. Referring again to FIG. 1, the support frame 124 extends between the fore and aft envelope housings 126, 128. As will be described in further detail below, the fore and aft envelope housings 126, 128 are sized and shaped to house corresponding portions of the fore portion 106 and aft portion 108 (including in one example the tail portion 104) of the aerostat envelope 100 while the aerostat envelope is in a folded configuration and extending between the fore and aft envelope housings 126, 128.

As further shown in FIG. 1, a gondola 114 including, for instance, a payload disposed thereon, is suspended below the aerostat envelope 100, such as by flying lines 116. As shown in FIG. 1, in one example, the flying lines 116 are coupled with a tether 118 positioned below the gondola 114. The tether 118 is optionally coupled with a hoist system 120, for instance, including a winch having a spool of cable, filament, or the like of sufficient length to deploy the aerostat envelope 100 in the inflated configuration some distance above the support frame 124. In an example, the support frame 124 is positioned on the ground. The aerostat envelope 100, in one example, includes a gondola 114, as previously described. The gondola 114 optionally is a support frame suspended beneath the aerostat, for instance, by the flying lines 116, as described above. The gondola 114, in one example, includes one or more systems such as sensor systems, cameras, and the like positioned beneath the aerostat envelope 100 and useable when the aerostat envelope 100 is deployed, for instance, some distance above the ground.

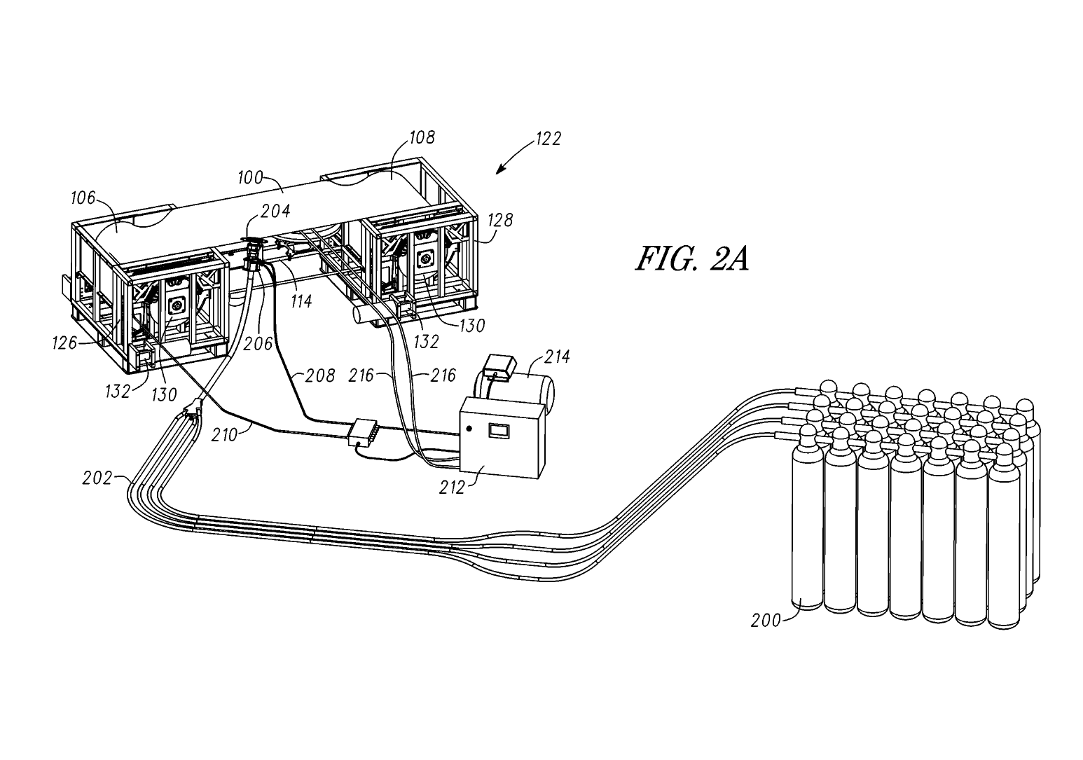

FIG. 2A shows the aerostat deployment system 122. As shown, the aerostat deployment system 122 further includes an inflation gas source 200 coupled with the aerostat envelope 100, for instance, by gas tubing 202 extending therebetween. In one example, the inflation gas source 200 includes one or more tanks of helium gas or other lighter than air gas configured to inflate the aerostat envelope 100. Inflating the aerostat envelope 100 makes the aerostat envelope 100 buoyant in atmosphere to accordingly lift the gondola 114, including the payload thereon, to a desired altitude.

The aerostat envelope 100 is shown in FIG. 2A in a folded configuration and positioned between the fore and aft envelope housings 126, 128. As will be described in further detail below, the aerostat envelope 100 is, in one example, folded in a predetermined configuration to allow for rolling of the fore portion and aft portion 106, 108 for packaging into the fore and aft envelope housings 126, 128. For instance, the folded fore and aft portions 106, 108 are rolled or stored within the fore and aft envelope housings 126, 128. The fore and aft envelope housings 126, 128 are thereafter operated, for instance by a programmed logic controller (PLC) contained within a control enclosure 212, to deploy the aerostat envelope 100 in a metered manner to ensure the aerostat envelope 100 is inflated in a rapid, predictable, and controlled method. Such inflation and deployment of the aerostat envelope ensures that a small number of operators (e.g., four or fewer) may control the aerostat envelope 100 until the aerostat envelope is deployed, for instance, according to playing out of the tether 118 by way of the hoist system 120 shown in FIG. 1.

Referring again to FIG. 2A, the aerostat envelope 100 is coupled with the inflation gas source 200, for instance, with the gas tubing 202, as previously described above. In one example, the aerostat envelope 100 includes an inflation port 204 sized and shaped to couple with a quick disconnect coupling 206 provided at one end of the gas tubing 202. Optionally, a coupling air line 208 is provided to the quick disconnect coupling 206 to remotely operate the quick disconnect coupling and thereby detach the gas tubing 202 from the inflation port 204, for instance, after full inflation of the aerostat envelope 100 into the inflated configuration shown in FIG. 1. In another example, coupling air lines 210 extend to and are coupled with one or more brake systems associated with one or both of the fore and aft envelope housings 126, 128. As shown in FIG. 2A, the coupling air line 208 and the envelope housing air line 210 are coupled with a compressor 214 associated with the PLC, located in one example within a control enclosure 212. The PLC is configured to control operation of the compressor 214 and control operation of one or more valves to allow the delivery or interruption of delivery of air through the coupling air line 208, the quick disconnect coupling 206, and the envelope housing air line 210 to, for instance, one or more brakes associated with the fore or the aft envelope housings 126, 128.

In another example and as further described below, the PLC (in the control enclosure 212) is configured to cooperate with the brakes of each of the fore and aft envelope housing 126, 128 to control the deployment of the aerostat envelope 100 during inflation of the envelope. For instance, the PLC gradually meters out a portion of one or both of the fore and aft portions 106, 108 of the aerostat envelope 100 during inflation to accordingly control a pressure within the aerostat envelope 100 and thereby minimize skin stresses in the fabric of the aerostat envelope 100. In one example, pressure tubing 216 is coupled with pressure sensors positioned on or within the aerostat envelope 100. The PLC monitors the pressure within the aerostat envelope 100 and accordingly gradually frees the aerostat envelope 100 to deploy. For instance, the PLC operates the brakes of one or more of the fore and aft envelope housings 126, 128 to accordingly deploy the aerostat envelope 100 and allow for continued inflation of the larger volume of the aerostat envelope. For instance, in one example, deployment of the tail portion 104 is preferred to ensure the tail portion 104 including the plurality of fins 110 are first deployed relative to the fore portion 106 including, for instance, the nose of the aerostat envelope 100. The control components of the control enclosure 212, such as a PLC, accordingly release the aft portion 108 of the aerostat envelope 100 through operation of one or more brakes within the aft envelope housing 128 (e.g., through delivery or cessation of delivery of pressurized air through an airline such as an envelope housing air line 210). The aft portion 108 is thereby accordingly deployed first relative to the fore portion 106 of the aerostat envelope 100 providing a more aerodynamic profile to the aerostat envelope 100 during inflation.

After inflation of the tail portion 104 and at least a portion of the aft portion 108, the PLC, in another example, is configured to meter out the fore portion 106 of the aerostat envelope 100 for inflation of the fore portion 106 of the envelope. Stated another way, the PLC within the control enclosure 212 is, in one example, configured to ensure the aft portion 108 of the aerostat envelope 100 deploys first and the fore portion 106 deploys second to provide an aerodynamic profile for the aerostat envelope 100 during deployment and accordingly ensure one or more operators are able to easily control the aerostat envelope 100 during the inflation process.

Referring now to FIG. 2B, the aerostat deployment system 122 is shown again with the aerostat envelope 100 removed to reveal the gondola 114, including one or more payload features provided on the gondola 114. As shown, each of the fore and aft envelope housings 126, 128 are positioned along the support frame 124. In the example shown in FIG. 2B, a payload recess 226 is provided between the fore and aft envelope housings 126, 128. The gondola 114, as well as the payload positioned on the gondola, are sized and shaped for positioning between the fore and aft envelope housings 126, 128. As shown in FIG. 2B, in one example, the payload extends across the payload recess 226 for engagement with each the fore and aft envelope housings 126, 128 to support the payload and the gondola 114 thereon, for instance, during transportation, storage and the like.

Referring now to the fore and aft envelope housings 126, 128 shown in FIG. 2B, each of the housings includes a housing body 220 sized and shaped to receive the respective fore and aft portions 106, 108 (see FIG. 1) of the envelope therein. For instance, each of the housing bodies 220 includes corresponding housing recess 222 sized and shaped to receive the respective portions of the aerostat envelope 100 therein. As shown in FIG. 2A, the remainder of the aerostat envelope 100 extends between the fore and aft envelope housings 126, 128, for instance, over top of the gondola 114 and the payload positioned on the gondola. The aerostat envelope 100 is coupled with the gondola 114, for instance, by the flying lines 116 previously shown in FIG. 1. That is to say, in the folded configuration with the aerostat envelope 100 positioned in each of the fore and aft envelope housings 126, 128, the aerostat envelope is coupled with the gondola 114 prior to deployment (e.g., inflation) and the aerostat deployment system 122 is thereby provided with the payload and gondola 114 preinstalled with the aerostat envelope 100. The aerostat envelope 100 may thereby be deployed into the configuration shown in FIG. 1 without installation of the gondola 114, for instance, after inflation of the aerostat envelope 100.

Referring again to FIG. 2B, one or both of the fore and aft envelope housings 126, 128 includes a brake assembly 224. In one example, the brake assembly 224 includes one or more brake systems sized and shaped to control the deployment of the fore and aft portions 106, 108 of the aerostat envelope 100. For instance, as described in further detail below, the brake assemblies 224 are coupled with spindles sized and shaped to wrap the respective fore and aft portions 106, 108 there around. Selective engagement and disengagement of the brake assembly relative to the spindle allows the spindle to rotate and thereby accordingly allows one or more of the fore and aft portions 106, 108 to deploy as needed during inflation. The brake assemblies 224, include, but are not limited to, disc brake assemblies, drum brake assemblies, controllers, sprockets, cogs, belt systems, and the like. The brake assemblies 224 ensure the spindles having one of the fore or aft portions 106, 108 of the aerostat envelope 100 wrapped therearound, are operated in a controlled fashion to thereby accordingly deploy the fore and aft portions 106, 108 in a metered manner to substantially control the inflation and deployment of the aerostat envelope 100 as described herein.

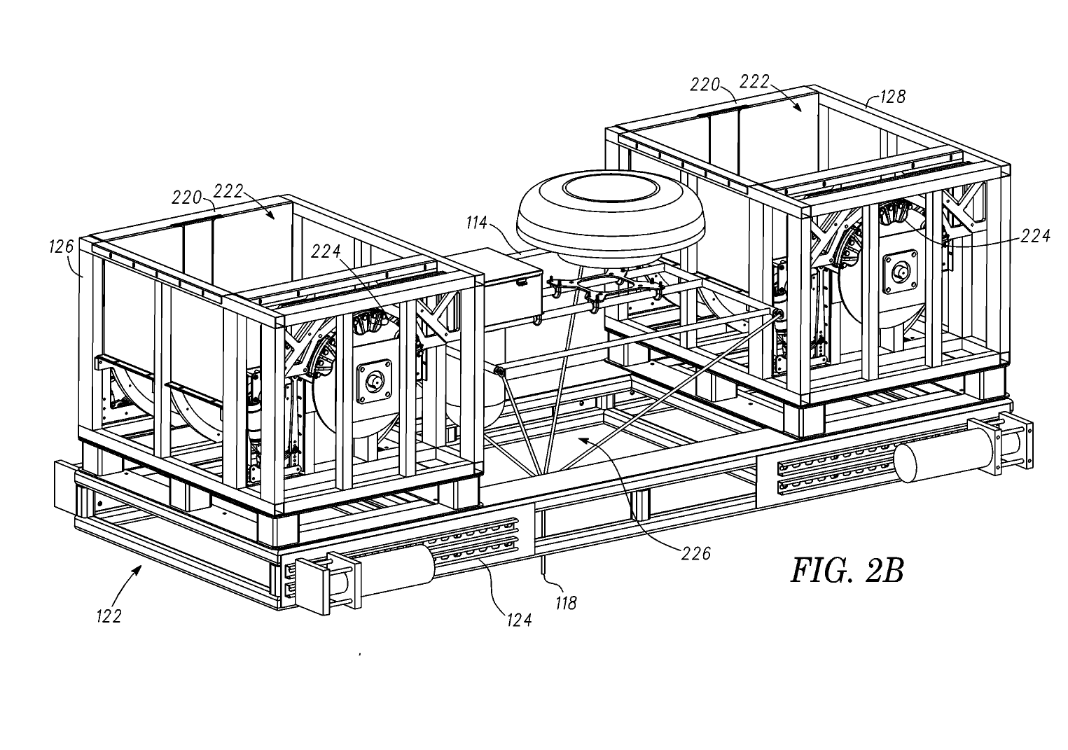

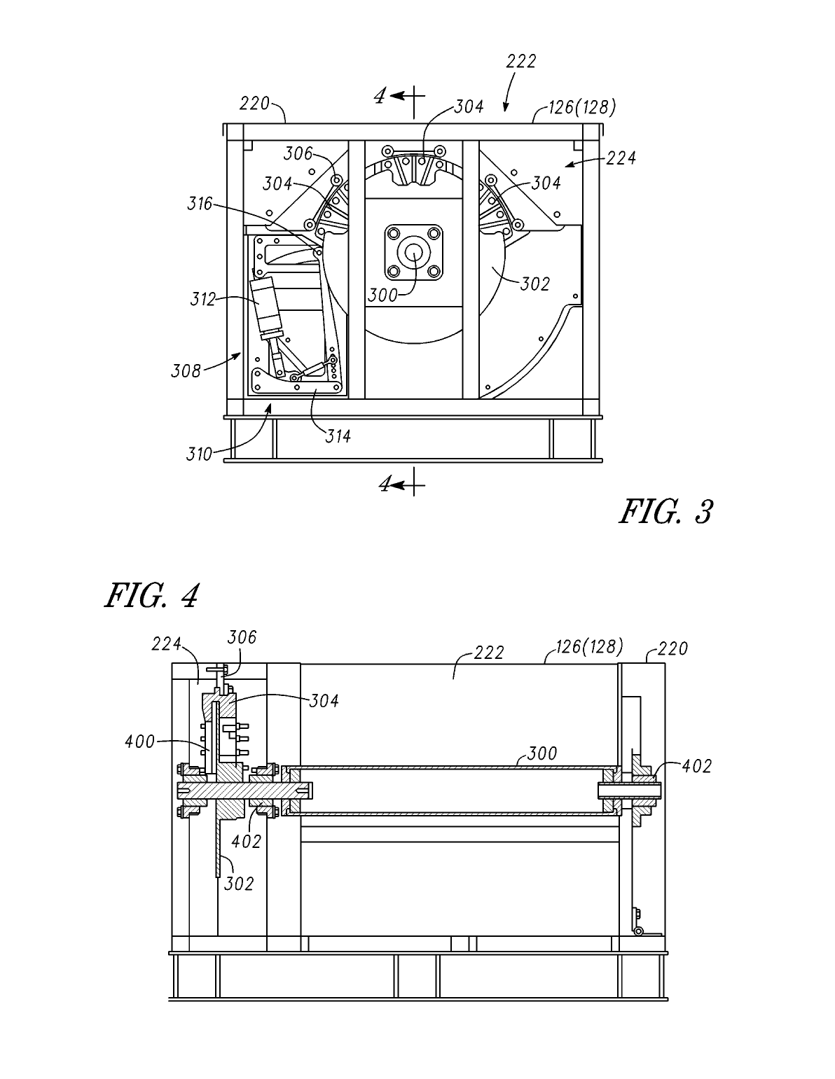

FIGS. 3 and 4 show examples of the envelope housings, for instance, the envelope housings 126, 128 previously described herein. Each of the fore and aft envelope housings 126, 128 include a housing body 220 having a housing recess 222 therein sized and shaped to receive folded portions of the aerostat envelope 100, such as respective fore and aft portions 106, 108 therein. A spindle 300 is shown extending between sides of the housing body 220. The spindle 300 is supported on spindle bearings 402 coupled adjacent to either side of the housing body 220. The spindle bearings 402 include, in one example, ball bearings, needle bearings, or the like that allow for rotation of the spindle 300 relative to the housing body 220 and deployment of the fore or aft portions 106, 108 of the aerostat envelope 100 during an inflation procedure.

FIGS. 3 and 4 show one example of a brake system, in this instance, a disc brake assembly 224 coupled with the spindle 300. Additionally, FIG. 3 shows another example of a brake system such as a pinch roller assembly 308 sized and shaped to gradually meter out the aerostat envelope 100 during an inflation (deployment) procedure. The pinch roller assembly 308 provides consistent pressure to the aerostat envelope 100 between the pinch roller and the spindle 300 to ensure the aerostat envelope 100 is maintained in the folded configuration along the spindle 300 prior to and during deployment. In contrast, the brake assembly 224 including, for instance, the disc brake assembly shown in FIGS. 3 and 4 operates the spindle 300 and prevents and allows rotation of the spindle 300 and corresponding deployment of the aerostat envelope 100 gradually, for instance, according to operation of the PLC previously shown in FIG. 2A.

Referring now to FIG. 3, the brake assembly 224, for instance a disc brake assembly includes, a rotor 302 rotatably coupled with the spindle 300. One or more brake pad assemblies 304 are arranged around the rotor 302 as shown. In one example, the brake pad assemblies 304 are coupled with the brake pad assembly cowling 306 coupled with the housing body 220, as shown in FIG. 3. Referring to FIG. 4, the brake pad assemblies 304, in one example, include brake pads 400 sized and shaped to selectively engage with the rotor 302 during operation of the brake assembly 224. Engagement of the brake pads 400 with the rotor 302 substantially prevents rotation of the rotor 302 and correspondingly prevents rotation of the spindle 300. Accordingly, deployment of the fore portion 106 of the aerostat envelope 100 is substantially prevented (e.g., while the aft portion 108 with the tail portion 104 and fins 110 proceeds).

Referring again to FIG. 3, in another example described herein, the fore or aft envelope housings 126, 128 include another brake assembly, such as a pinch roller assembly 308. As shown, the pinch roller assembly 308 includes a pinch roller linkage 310 coupled with the pinch roller 316. Operation of the pinch roller linkage 310, for instance, a four bar linkage biases the pinch roller 316 into varying positions, for instance, along an arcuate track formed in the housing body 220. The pinch roller 316 is thereby selectively moved closer and away from the spindle 300 according to the amount of the aerostat envelope 100 remaining on each respective spindle 300. That is to say, the pinch roller linkage 310 when operated by an air cylinder 312, for instance, selectively moves the pinch roller 316 gradually closer to the spindle 300 to ensure that the aerostat envelope 100, such as the fore portion 106, is snugly engaged along the spindle 300 during a deployment operation. As the aerostat envelope 100 is gradually deployed off the spindle 300 the air cylinder 312 is gradually operated to correspondingly move the pinch roller 316 toward the spindle 300 and ensure that the remainder of the aerostat envelope 100 still wrapped around the spindle 300 is snugly engaged to the spindle 300 and is accordingly metered out from the spindle 300 during inflation in a controlled and folded manner. As further shown in FIG. 3, in one example, the pinch roller linkage 310 is coupled with a pinch roller base 314. For instance, one or more links of the pinch roller linkage 310 are rotatably coupled with the pinch roller base 314 and the base thereby provides structural support to the pinch roller assembly 308 during operation and movement of the pinch roller 316 relative to the spindle 300.

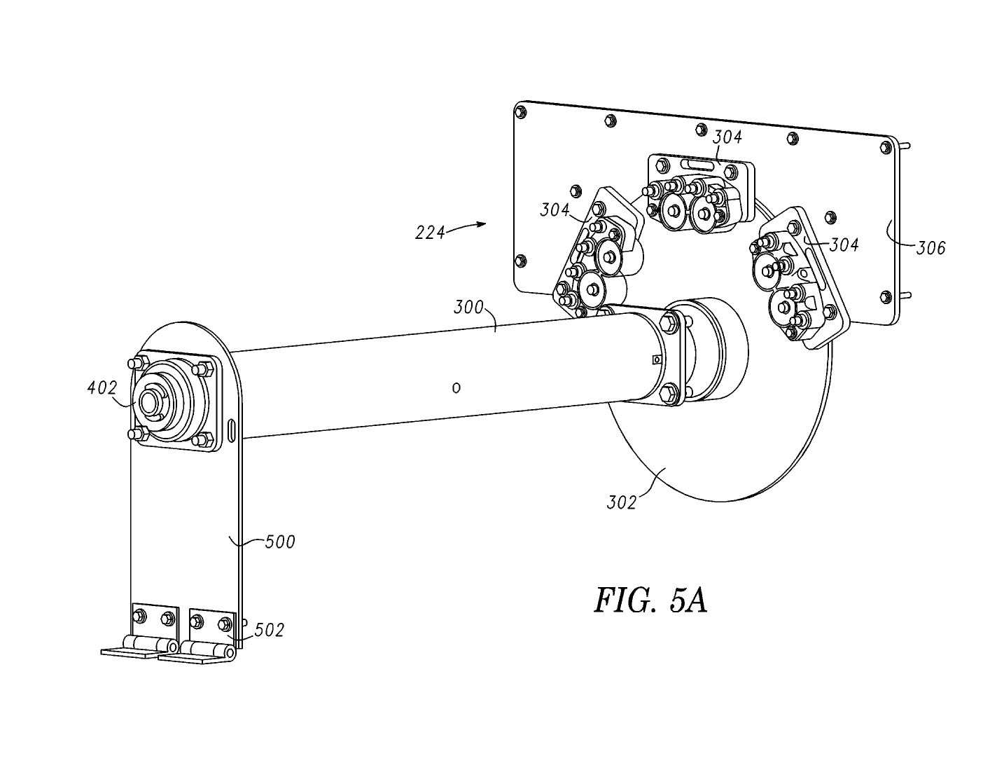

Referring now to FIG. 5A, one example of a portion of the fore or aft envelope housing 126, 128 (see FIG. 1) is provided. As shown, the spindle 300 extends between a spindle latch bar 500 including a spindle bearing 402 therein and the brake assembly 224. In one example, the brake assembly 224 (see FIGS. 3-4) includes a disc brake assembly having a rotor 302, brake pad assembly 304, and a brake pad assembly cowling 306 sized and shaped to hold the brake pad assembly 304 in the positional relationship shown in FIG. 5A. The spindle bearing 402 is positioned behind the rotor 302 as shown, for instance, in FIG. 4. As shown in the arrangement in FIG. 5A, the spindle 300 is rotatably coupled with the spindle latch bar 500 as well as the corresponding opposed bearing 402 of the fore or aft envelope housings 126, 128 shown.

In the example shown in FIG. 5A, the spindle 300 is coupled with the spindle latch bar 500. As shown in FIG. 5A, the spindle latch bar 500 is in turn rotatably coupled with a latch bar hinge 502. The latch bar hinge 502, as well as the spindle latch bar 500, allow for the easy opening of the spindle 300 and installation of the spindle 300 including, for instance, one or more of the fore or aft portions 106, 108 of the aerostat envelope 100 in a rolled configuration on the spindle 300. For instance, a spindle 300, uncoupled with the fore or aft envelope housings 126, 128, is rolled with the folded aerostat envelope 100 (e.g., one of the fore or aft portions 106, 108 and loaded into the fore or aft envelope housings 126, 128, for instance, by coupling with the brake assembly 224 and the spindle latch bar 500. The spindle latch bar 500 is rotated into position with the spindle 300, thereby locking the spindle in place. The spindle 300, after loading into the fore or aft envelope housings 126, 128, is then ready with the aerostat envelope 100 positioned there around for deployment, as described herein.

In another example, the aerostat envelope 100, including one of the fore or aft portions 106, 108, is rolled into the folded configuration described herein and thereafter loaded onto the spindle 300 previously installed within the fore or aft envelope housings 126, 128. For instance, the spindle latch bar 500 is rotated out of engagement with the spindle 300 thereby providing access to the spindle 300 for the rolled envelope 100. The envelope is slipped over the spindle 300 and the spindle latch bar 500 is there after rotated into the coupling orientation shown in FIG. 5A. In one example, the spindle latch bar 500 is coupled with the spindle 300, for instance, with a clip, mechanical fitting, or the like sized and shaped to ensure the spindle 300 is rotatably coupled with the spindle latch bar 500.

Referring now to FIG. 5B, another portion of the fore or aft envelope housings 126, 128 is shown. In this example, the housing body 220 is removed to expose the pinch roller assembly 308 previously shown in FIG. 3. The spindle 300 and the spindle latch bar 500, previously described in FIG. 5A, are provided herein as a point of reference when describing the pinch roller 316 shown in FIG. 5B. The pinch roller assembly 308 includes the pinch roller linkage 310 that converts, for instance, linear movement of the air cylinder 312 into corresponding translational movement of the pinch roller 316 with respect to the spindle 300 (e.g., translational movement toward and away from the spindle 300). As shown in FIG. 5B, the pinch roller assembly 308 includes a pinch roller frame 510. A shown the pinch roller frame 510, in one example, is coupled with the pinch roller base 314. The pinch roller frame 510 provides a peripheral framework for the pinch roller 316 that isolates the roller from the movement parts of the pinch roller assembly. Similarly, the pinch roller frame 510 isolates the pinch roller linkage from the envelope wrapped around the spindle 300.

As previously described, the pinch roller assembly 308 includes a pinch roller linkage 310. Referring to FIG. 5B, the pinch roller linkage 310 includes, in one example, the air cylinder 312 coupled with a bell crank 504. The bell crank 504 is pivotally coupled with a pivot point 505 in the pinch roller base 314 (e.g., coupled with the pinch roller frame 510). The bell crank 504 is also rotatably coupled with intermediate link 506 extending between the bell crank 504 and a portion of the pinch roller link 508. As shown in FIG. 5B, the pinch roller link 508 is rotatably coupled with a portion of the pinch roller base 314 and the pinch roller 316.

As shown in FIG. 5B, the air cylinder 312 is configured to move the pinch roller 316 through corresponding operation of the pinch roller linkage 310. Optionally, the air cylinder 312 includes but is not limited to a hydraulic cylinder, an air based cylinder, or other actuating means, for instance, a solenoid or the like. In one example, retraction of the air cylinder 312 moves the bell crank 504 in a counter-clockwise fashion around the pivot point 505. The bell crank 504 thereby pulls the intermediate link 506 away from the spindle 300 and accordingly moves the pinch roller link 508 away from the spindle 300. The pinch roller 316 provided at the opposed end of the pinch roller link 508 is thereby pulled away from the spindle 300. In one example, the pinch roller 316 is moved away from the spindle 300, for instance, during loading of the spindle into the fore or aft envelope housings 126, 128.

Similarly, extension of the air cylinder 312 correspondingly biases the pinch roller 316 into a closer position relative to the spindle 300. For instance, the extension of the air cylinder 312 correspondingly lengthens the air cylinder and moves the bell crank 504 about the pivot point 505 in a clockwise fashion. The movement of the bell crank 504 correspondingly pushes the intermediate link 506 toward the spindle 300 and accordingly moves the pinch roller link 508 toward the spindle 300. The pinch roller 316 provided at an end of the pinch roller link 508 is accordingly moved closer to the spindle 300 with extension of the cylinder 312, as described herein. In another example, the air cylinder 312 including, for instance, a hydraulic cylinder, solenoid, or the like includes any sort of actuator configured to provide translational or rotational movement and such movement is used in a different fashion with a different linkage to provide movement of the pinch roller 316 closer to and away from the spindle 300 as dictated by the linkage 310 or the configuration of the actuator, such as the air cylinder 312.

In the example shown in FIG. 5B, an optional second pinch roller assembly 308 is provided at an opposed end of the pinch roller 316. Operation of dual pinch roller assemblies 308 ensures that pinch roller 316 is reliably moved from both ends to ensure consistent pinching engagement with the spindle 300 parallel mounted to the pinch roller 316. Stated another way, the provision of dual pinch roller assemblies 308 substantially prevents the misalignment or tilting of the pinch roller 316 relative to the spindle 300 and accordingly keeps the portion of the aerostat envelope 100 positioned therebetween substantially flat without pinching one side of the aerostat envelope 100 more so relative to another side.

FIG. 5B also shows an envelope trough 512 extending beneath the spindle 300. In one example, the envelope trough 512 cooperates with the envelope 100 coupled around the spindle 300 to ensure that the envelope 100 is supported while in the stored configuration around the spindle 300 and during deployment, for instance, by metering of the envelope 100 from between the spindle 300 and pinch roller 316. That is to say, the envelope trough 512, in one example, substantially prevents loose portions of the envelope 100 from drifting below the fore or aft envelope housings 126, 128 and thereby minimizes any risk of the envelope 100 becoming fouled in other portions of the fore or aft envelope housings 126, 128. Additionally, in another example, the envelope trough 512 provides a smooth surface to assist in the installation of the spindle 300 with the folded fore or aft portion 106, 108 of the aerostat envelope 100 thereon. For instance, the envelope trough 512 provides a smooth surface to assist operators in loading the aerostat envelope 100 into the fore or aft envelope housings 126, 128.

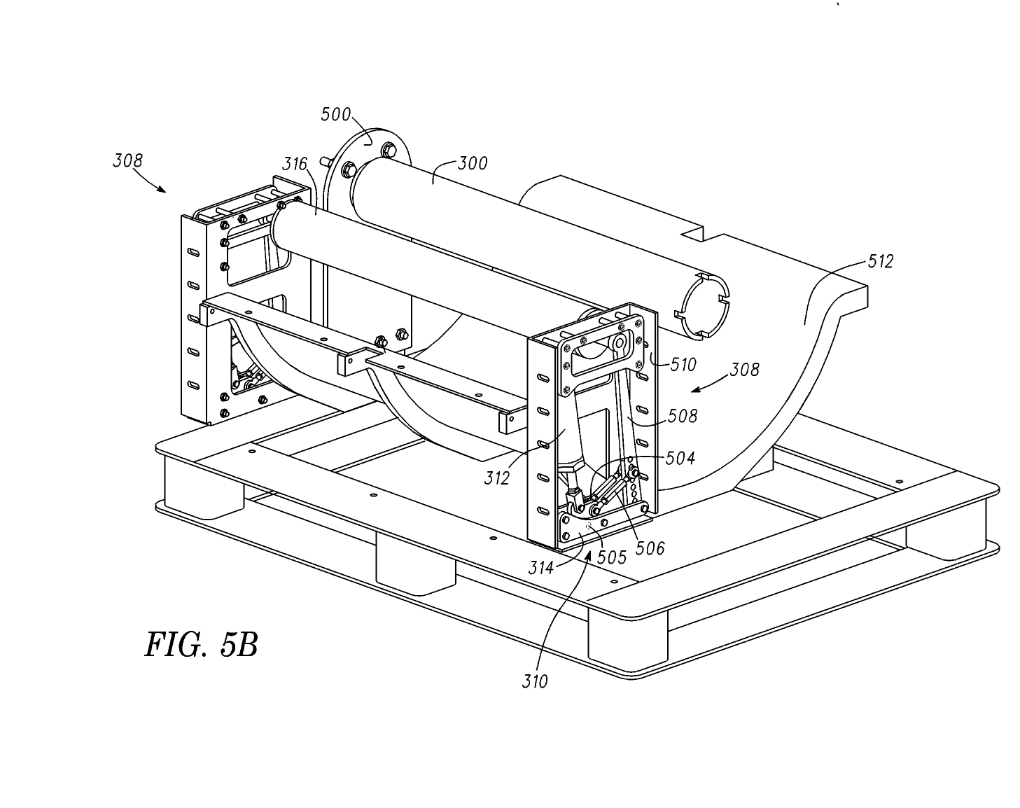

FIG. 6 shows one example of a gondola 114 previously described and shown in FIG. 1. In the example shown in FIG. 6, the gondola 114 includes a gondola frame 606 supporting a first instrument 600 and a second instrument 604. Optionally, the gondola frame 606 may be larger or smaller than the configuration shown to allow for the coupling of fewer or more instruments relative to the instrument shown in FIG. 6. In one example, the gondola frame 606 is a skeletal frame composed of a number of bars that allow for the positioning of one or more of the instruments, such as the second instrument 604, through a portion of the gondola frame 606 thereby allowing uninterrupted access of the one or more instruments. to an area underneath the gondola 114. In one example, the second instrument 604 includes but is not limited to an optical instrument configured to observe the ground underlying or extending away from the aerostat envelope 100 while the aerostat envelope is deployed, for instance, at an altitude some distance above the ground. The second instrument 604, as installed in FIG. 6, is thereby able to observe the ground without the gondola frame 606 interfering or interrupting.

In another example, the gondola frame 606 includes an instrument mount 602, such as a bracket with legs sized and shaped to couple with the gondola frame 606 and provide a mounting surface for coupling with an instrument, such as the first instrument 600. The first or second instruments 600, 604 include, but are not limited to, sensors, cameras, optical instruments, relay systems, radio systems, satellite communication devises, and the like. For instance, the first and second instruments 600, 604 are not limited to simply instruments but may also include telecommunication and communication modules, such as antennas, receivers, and the like.

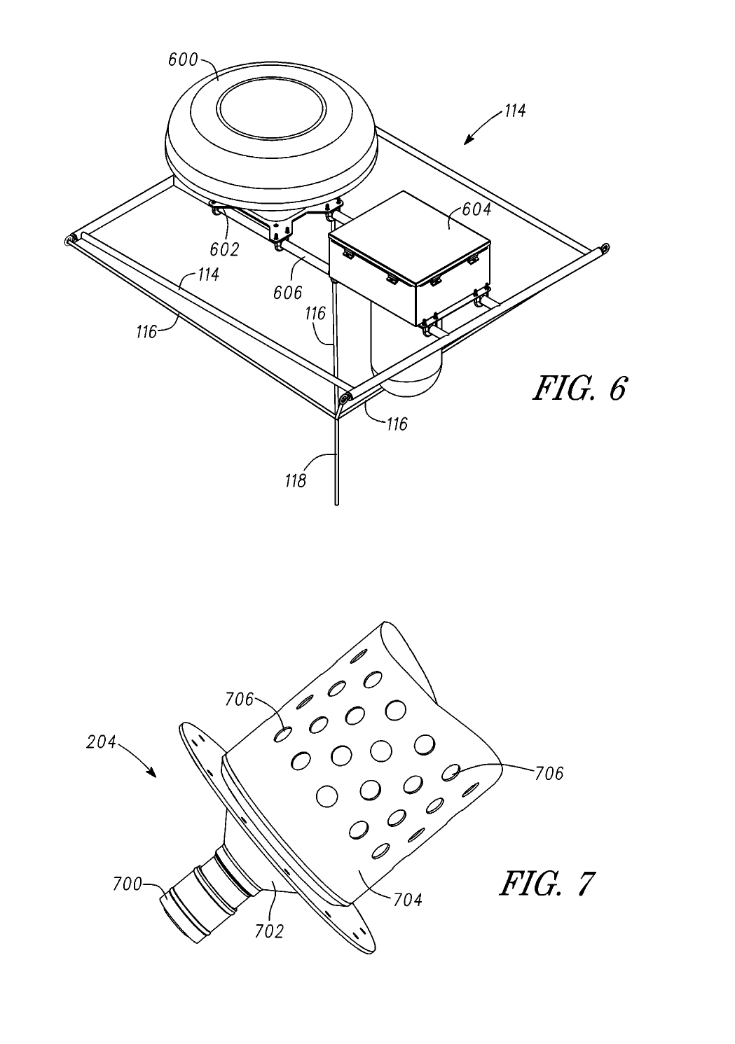

FIG. 7 shows one example of an inflation port 204, as previously shown in FIG. 2A. In the example shown in FIG. 7, the inflation port 204 includes a port nozzle 700 sized and shaped to extend from the aerostat envelope 100, for instance, as shown in FIG. 2A. The inflation port 204 further includes in the examples shown a port installation flange 702 sized and shaped for coupling with the aerostat envelope 100, for instance, the fabric comprising the aerostat envelope. As shown in FIG. 7, the port installation flange 702 has a substantially flat configuration above the port nozzle 700. The flat configuration of the port installation flange 702 allows the inflation port 204 to substantially lay flat within the aerostat envelope 100, thereby facilitating the folding of the aerostat envelope 100 during packing and prior to loading into the fore and aft envelope housing 126, 128.

Additionally, the inflation port 204 includes a pliable gas diffuser 704 having a plurality of diffuser orifices 706 shown therein. In one example, the pliable gas diffuser 704 is a fabric based gas diffuser having orifices provided at one end of the diffuser to facilitate the diffusion of inflation gases as it is delivered from the inflation gas source 200, for instance, through the gas tubing 202 to the inflation port 204 (see FIG. 2A). The pliable gas diffuser 704 substantially prevents the rapid uncontrolled delivery of gas into the aerostat envelope 100 and thereby substantially mitigates any initial spikes and skin stress to the aerostat envelope 100 and accordingly protects and prevents damage to the aerostat envelope 100 at the initial stages of inflation. Additionally, because the gas diffuser 704 is constructed with a pliable material the gas diffuser 704 is able to readily deflect into any form as needed during folding of the aerostat envelope 100, for instance, prior to packaging within the fore and aft envelope housings 126, 128. After loading the envelope into the fore and aft envelope housings 126, 128, the gas tubing 202 is coupled with the inflation ports such as the port nozzle 700 and is thereafter ready for inflation. Delivery of gas through the gas tubing 202 is diffused by the pliable gas diffuser 704 and thereafter delivered to the interior of the aerostat envelope 100.

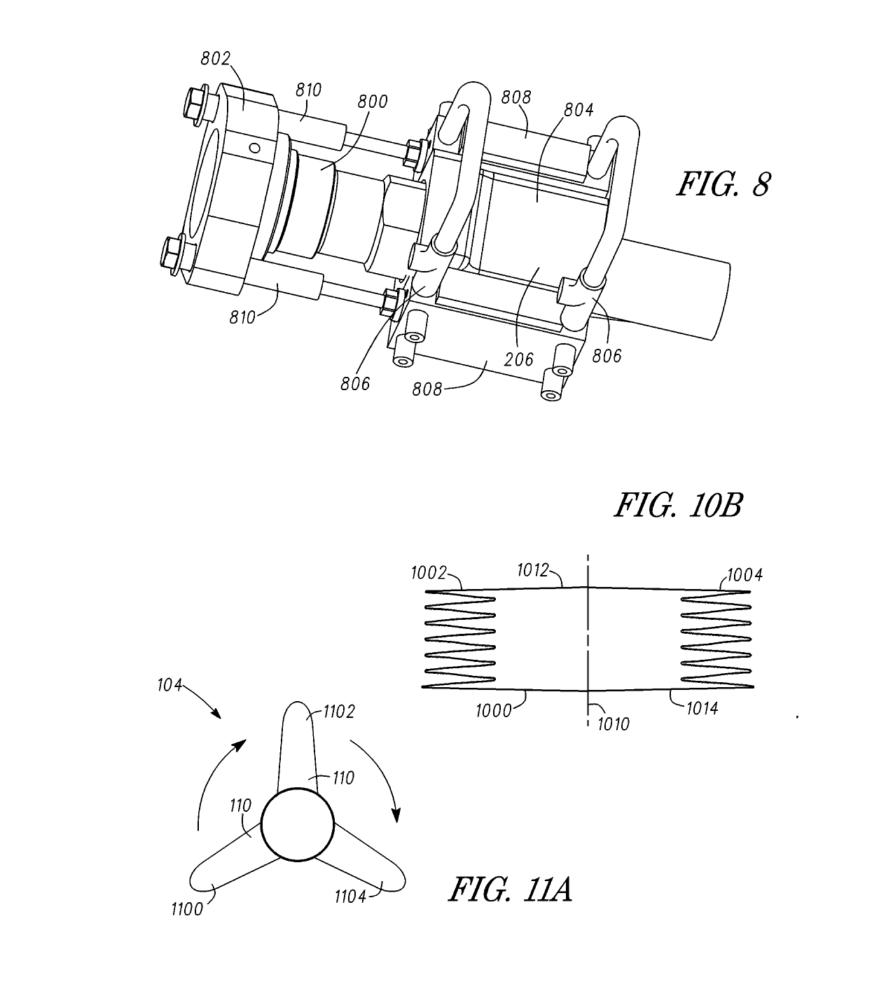

Referring now to FIG. 8, one example of a quick disconnect coupling 206 as previously shown in FIG. 2A is provided. As shown, the quick disconnect coupling 206 includes a nozzle receptacle 800 sized and shaped to receive a nozzle, such as the port nozzle 700 previously shown in FIG. 7. Additionally, the quick disconnect coupling 206 includes in the example shown a disconnect collar 802 removably coupled around the nozzle receptacle 800. The disconnect collar 802 is sized and shaped to engage with the portion of the port nozzle 700 of the inflation port 204 to allow for quick disconnect of the gas tubing 202, for instance, by movement of the collar 802 relative to the nozzle receptacle 800.

As further shown in FIG. 8, an actuator housing 804 is coupled with the disconnect collar 802. For instance, the actuator housing 804 includes one or more actuators 808 sized and shaped to move the disconnect collar 802 relative to the nozzle receptacle 800. In one example, the actuator housing 804 includes a plurality of air manifolds 806 (alternatively hydraulic fluid manifolds or the like) that deliver air under pressure to the actuators 808 positioned on either side of the actuator housing 804. In one example, the actuators 808 include, but are not limited, to air cylinders having pistons disposed therein. The actuator pistons 810 are shown coupled between the actuator housing 804 and the disconnect collar 802.

In operation, as the aerostat envelope 100 is inflated to the configuration shown in FIG. 1, the programmed logic controller, shown by the control enclosure 212 in FIG. 2A, opens a valve allowing for the delivery of air (or cessation of delivery of air) to the actuator housing 804 of the quick disconnect coupling 206. The actuators 808 correspondingly move the actuator pistons 810. In one example, movement of the actuator pistons 810 causes contraction of the pistons relative to the actuator housing 804 and correspondingly moves the disconnect collar 802 toward the actuator housing 804, consequently moving the disconnect collar relative to the nozzle receptacle 800. This relative movement of the disconnect collar 802 correspondingly disconnects the quick disconnect coupling 206 from the port nozzle 700 of the inflation port 204. For example, the disconnect collar 802 includes a detent therein and movement of the disconnect collar 802 forces the detent out of engagement with a groove formed within the port nozzle 700. Because the aerostat envelope 100 is in the fully inflated position shown in FIG. 1, the weight of the quick disconnect coupling 206 in combination with the operation of the disconnect collar 802 allows the port nozzle 700 to detach from the quick disconnect coupling 206 and the coupling 206 falls away from the aerostat envelope 100 under the force of gravity.

In one example, the quick disconnect coupling 206 is able to act and thereby disconnect itself from the aerostat envelope 100, for instance, at the inflation port 204 without operation by an operator. Stated another way, an operator is not needed to approach the inflation port 204 and disconnect the gas tube from the aerostat envelope 100. Instead, the operator may operate the quick disconnect coupling, for instance, from the PLC or the PLC may operate the quick disconnect coupling 206 automatically upon determining (e.g., through pressure measurements provided through the pressure tubing 216, see FIG. 2A) that inflation of the aerostat envelope 100 is complete.

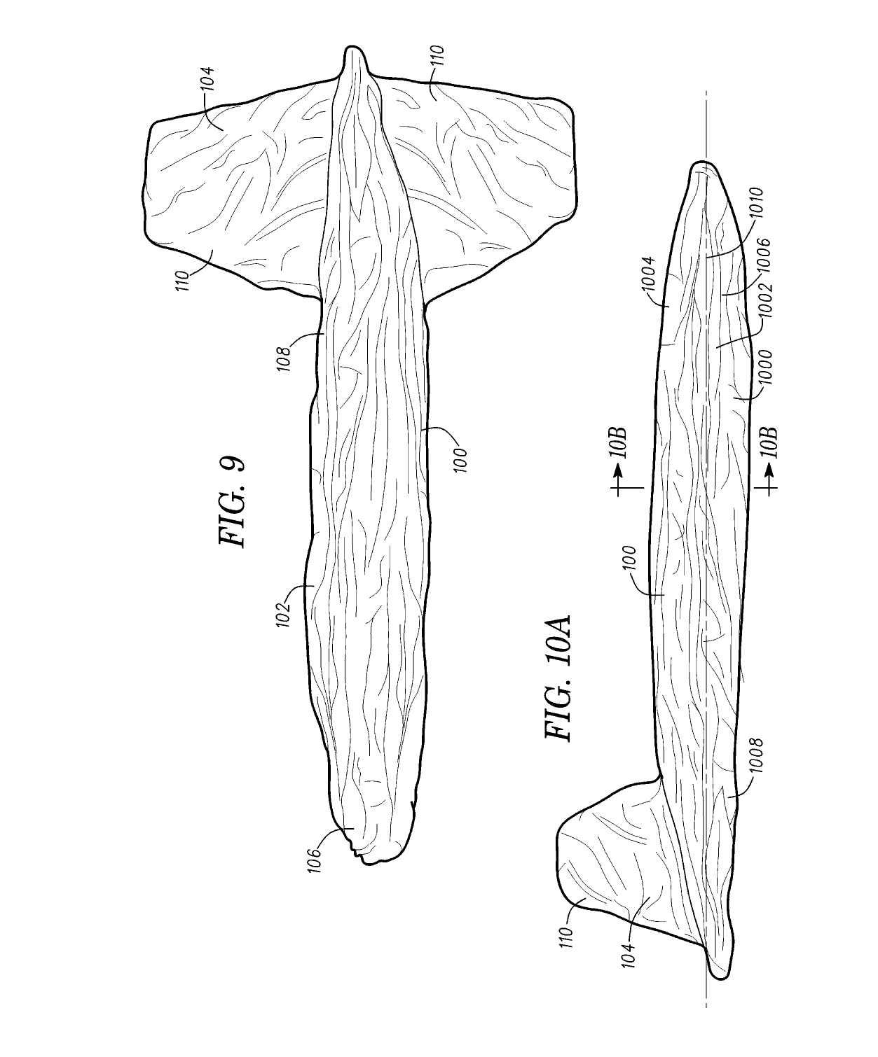

FIG. 9 shows the aerostat envelope 100 in a deflated condition laid out over a substantially planar surface such as a floor. As shown, the aerostat envelope 100 includes the hull 102 extending between the fore portion 106 and the tail portion 104. As shown in FIG. 9, the aft portion 108 couples the fore portion 106 of the hull 102 with the tail portion 104. Optionally, the aft portion 108 includes the tail portion 104. The fins 110 are further shown in a deflated configuration with one or more of the fins positioned upwardly relative to the hull 100 and one more of the fins 110 positioned downwardly relative to the hull 102. The configuration shown in FIG. 9 provides the aerostat envelope 100 in an initial or preliminary condition prior to folding of the aerostat envelope 100, for instance, for packing within the aerostat deployment system 122 previously shown in FIG. 1 and further shown in FIGS. 2A and 2B.

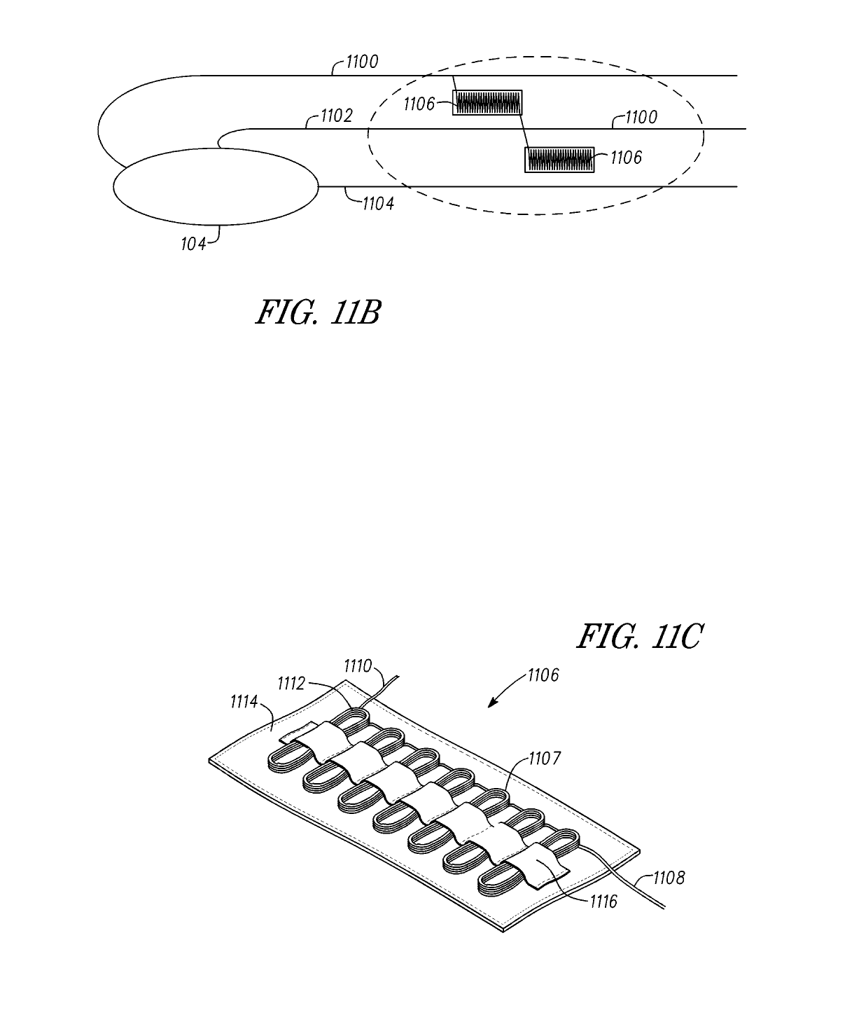

FIGS. 10A and 10B show the aerostat envelope 100 in a first intermediate configuration during the folding or packaging of the aerostat envelope 100, for instance, for storage within the aerostat deployment system 122. As shown in FIG. 10A, the folded envelope 1000 (e.g., in a folded core configuration) includes a left and right core 1002, 1004 folded, for instance, with accordion folds on either side of an envelope longitudinal center line 1010 shown in phantom lines in FIG. 10A. The left and right cores 1002, 1004 extend between the folded fore portion 1006 and the folded aft portion 1008. The tail portion 104 of the folded aft portion 1008 is in this configuration unfolded with the fins 110 shown on one side of the folded envelope 1000, for instance, the side of the right core 1004. Folding of the fins 110 will be described herein in detail below.

Referring now to FIG. 10B, a cross-sectional view of the folded envelope 1000 is provided. As shown, the left and right cores 1002, 1004 are positioned on either side of the envelope longitudinal center line 1010 (shown as a vertical plane in FIG. 10B). The folded envelope upper surface and folded envelope lower surface 1012, 1014 bridge between the left and right cores 1002, 1004 thereby providing the envelope pocket within. As shown by the cross-sectional view in FIG. 10B, the folded configuration of the left and right cores 1002, 1004 (e.g., an accordion fold configuration) extends between the folded fore portion 1006 and the folded aft portion 1008 shown in FIG. 10A.

As will be described in further detail below, providing the folded envelope configuration 1000 shown in FIG. 10A allows for ready inflation of the aerostat envelope 100, for instance, into the inflated configuration shown in FIG. 1, and further allows for metered control of the folded fore and aft portions 1006, 1008 during deployment. Stated another way the fore and aft envelope housings 126, 128 in cooperation with the folded core configuration 1000 including the left and right cores 1002, 1004 are able to meter out the longitudinally extending aerostat envelope 100 to thereby control inflation of the aerostat envelope 100, for instance, by inflating the folded aft portion 1008 first including the tail portion 104 and thereafter inflating the folded fore portion 1006. Additionally, providing the folded envelope 1000 in the configuration shown in FIGS. 10A and 10B allows for easy wrapping of the envelope 100 around the spindles 300 of the fore and aft envelope housings 126, 128 shown, for instance, in FIGS. 3 and 4.

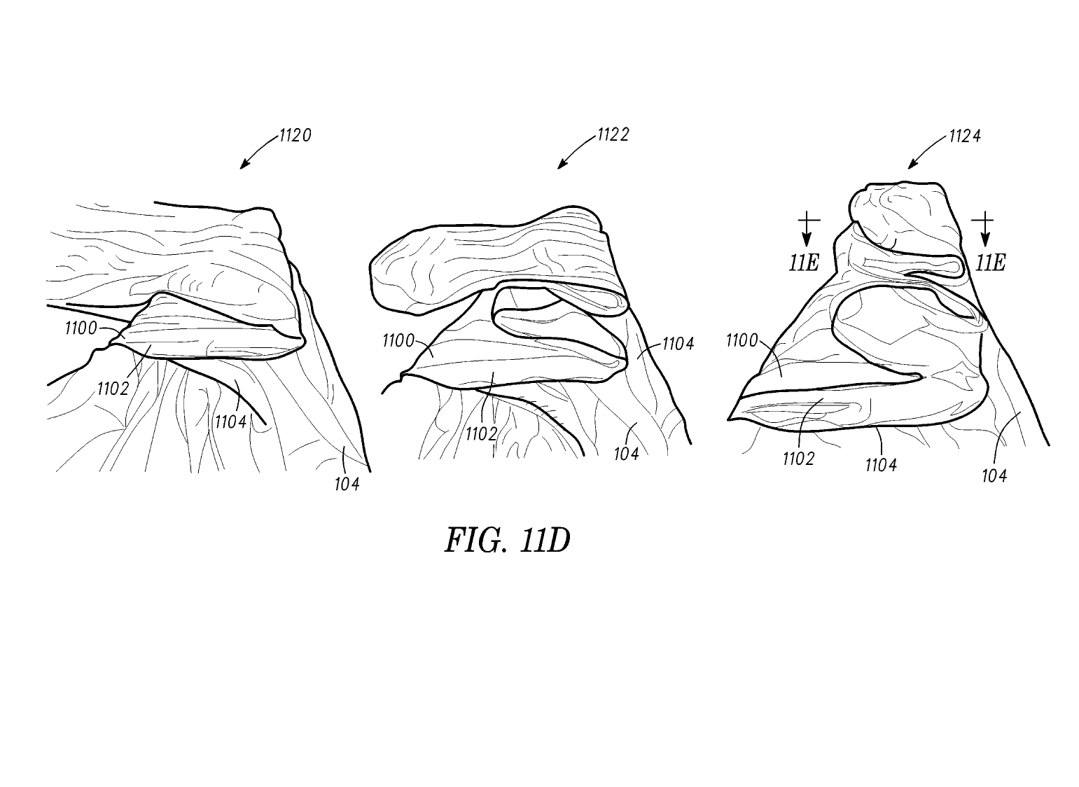

FIGS. 11A and 11B show the tail portion 104, for instance, of the folded aft portion 1008 shown in FIG. 10B in a prefolded configuration. As shown for instance, in FIG. 11A the fins 110 are positioned around the tail portion 104. That is to say a first fin, second fin, and third fin 1100, 1102, 1104 are positioned at substantially equidistant positions around the tail portion 104. Arrows are provided in FIG. 11A to show one example of movement of the fins 1100, 1102, 1104 into a folded configuration such as the configuration shown in FIG. 11B.

Referring to 11B, the tail portion 104 is shown in an intermediate folded configuration with the first fin 1100 folded on top of the second fin 1102 and the first and second fins folded on top of the third fin 1104 (e.g., with tail stems and tail tips of the fins laying over the other tail stems and tips, respectively). In another example, one or more of the fins are folded counter-clockwise as opposed to the clockwise fashion shown in FIG. 11B with the third fin 1104 positioned over top of the first and second fins 1100, 1102, respectively. In the configuration shown in FIG. 11B, at least portions of the fins 1100, 1102, 1104 are positioned adjacent to each other. In order to later control the inflation of the first, second, and third fins 1100, 1102, 1104, in one example, fin reefing patches 1106 are coupled between each of the adjacent fins. For instance, as shown in FIG. 11B a first fin reefing patch 1106 is coupled between the first and second fins 1100, 1102 as shown and a second fin reefing patch 1106 is coupled between the second and third fins 1102, 1104.

Referring now to FIG. 11C, a detailed top view of one fin reefing patch 1106 is provided. As shown, the fin reefing patch 1106 includes a reefing line 1107 extending through the fin reefing patch 1106. The reefing line 1107 includes, in one example, a reefing line first end 1108 and a reefing line second end 1110 opposed to the reefing line first end 1108. A portion of the reefing line such as a stored reefing line 1112 (a substantial portion of the reefing line 1107) is stored within the patch substrate 1114 in a serpentine configuration as shown in FIG. 11C. The patch substrate 1114 in one example includes line retaining features 1116 such as loops of the substrate material sized and shaped to receive the stored reefing line 1112 in the serpentine stored configuration shown in FIG. 11C. The line retaining features 1116, for instance, loops of fabric material of the patch substrate 1114 are sized and shaped to meter out the reefing line 1107 during deployment of the aerostat envelope 100 to ensure that the fins such as the first, second, and third fins 1100, 1102, 1104 are deployed in a controlled fashion into the configuration shown in FIG. 11A. Additionally, the fin reefing patches 1106, in another example, ensure that the folded aft portion 1008, shown in FIG. 10A, inflates in a controlled manner without inflation of the first, second, and third fins 1100, 1102, 1104 happening in an uncontrolled fashion relative to the folded aft portion 1008. Stated another way, the fin reefing patches 1106, provide a constraint to the inflation of the tail portion 104 to ensure that the folded aft portion 1008 inflates in a controlled manner wherein one or more of the folded aft portion 1008 and the tail portion 104 inflate as desired, for instance, with metering of the folded aft portion 1008 from its corresponding spindle 300 of the aft envelope housing 128 shown in FIG. 2A and FIG. 2B.

In one example, the fin reefing patch 1106 is sewn or attached to one or more of the fins 1100, 1102, 1104. For instance, the fin reefing patches 1106, each including the patch substrates 1114, are stitched into the first fin 1100 and the second fin 1102 as shown in FIG. 11B. In another example, one or more of the fin reefing patches 1106 are coupled with the second fin 1102. In any example, the reefing line first end 1108 is coupled with one of the first, second, or third fins 1100, 1102, 1104 and the reefing line second end 1110 of any one of the fin reefing patches 1106 is coupled with the opposed surface of the opposed fin, such as the first, second, or third fin 1100, 1102, 1104.

Referring now to FIG. 11D, the tail portion 104 is shown in a plurality of intermediate folded tail configurations 1120, 1122 and a final folded tail configuration 1124. As shown in the left most view, the tail portion 104 is shown in a first intermediate folded tail configuration 1120. The first, second, and third fins 1100, 1102, 1104 are provided in a partial accordion folded configuration with the remainder of the fins 1100, 1102,1104 extending to the left of the page. As shown, the folded portions of each of the fins 1100, 1102, 1104 are within the perimeter of the tail portion 104, for instance, the aft portion of the hull 102. The second intermediate folded tail configuration 1122 is provided in the middle view of FIG. 11D. In this configuration, the first, second, and third fins 1100, 1102, 1104 are further folded in an accordion configuration with only a small portion of the fins extending to the left of the remainder of the second intermediate folded tail configuration 1122. The final folded tail configuration 1124 is provided in the right most view in FIG. 11D. In this view, the first, second, and third fins 1100, 1102, 1104 are folded into the configuration shown and thereby positioned for storage (within a storage component such as tail sleeve described herein) and eventual wrapping within the aft envelop housing 128 shown for instance in FIGS. 1, 2A and 2B.

FIG. 11E shows a cross-sectional view taken along the line 11E-E in FIG. 11D. As shown the first, second, and third fins 1100, 1102, 1104 extend from the hull 102, for instance, the tail portion 104 of the hull. Each of the fins is folded one on top of the other and then folded into the accordion configuration shown in the cross-section of FIG. 11E (and previously described in the intermediate configurations 1120, 1122 and the final configuration 1124 of FIG. 11D).

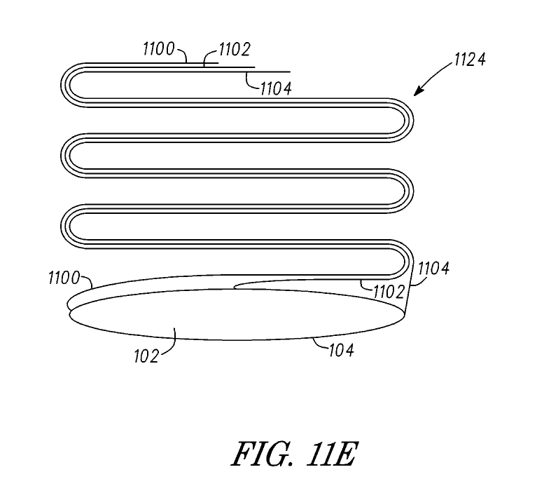

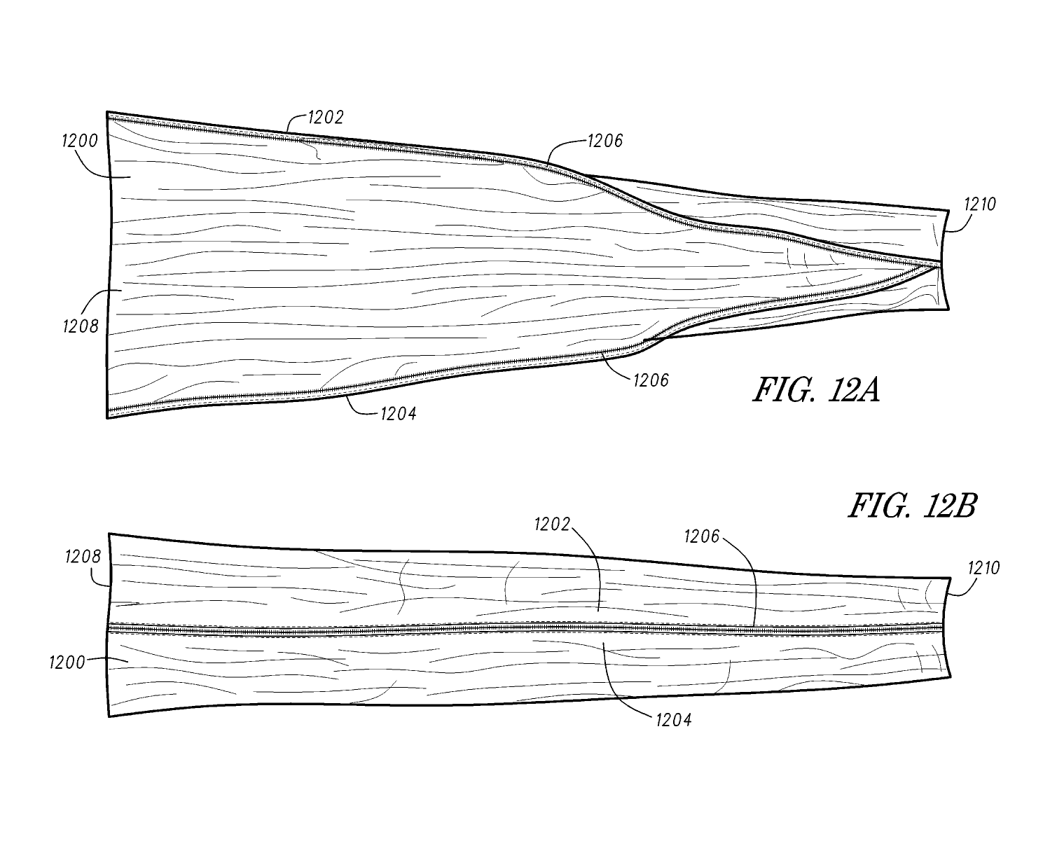

FIGS. 12A, 12B, and 13 show an optional component for the packing of the aerostat envelope 100. As first shown in FIG. 12A, a tail sleeve 1200 is provided in an open configuration with first and second sleeve edges 1202, 1204 spaced from each other to thereby expose the inside of the tail sleeve 1200. A fastener 1206, such as a zipper, hook and loop material, rivets, buttons, and the like extends along the tail sleeve 1200 to allow for coupling of the first and second sleeve edges 1202, 1204 as described herein. As will be described in further detail below, the tail sleeve 1200 includes a rolling mouth (e.g., an inflation control feature) sized and shaped to receive at a least a portion of the tail portion 104 therein. For instance, the fins 1100, 1102, 1104 shown previously in FIG. 11E are positioned within the tail sleeve 1200, as described herein, and the tail sleeve 1200 thereby controls the inflation of the fins during inflation of the aerostat envelope 100. The tail sleeve 1200 extends from the rolling mouth 1208 to a sleeve end 1210. In the example shown in FIG. 12A, the sleeve end 1210 is closed, for instance, stitched shut. In another example, the sleeve end 1210 is substantially open.

Referring now to FIG. 12B, the tail sleeve 1200 is shown in a closed configuration with the fastener 1206 fastening the first and second sleeve edges 1202, 1204. As previously described, the fastener 1206 includes, but is not limited to, hook and loop material, a zipper, rivets, buttons, and the like that fasten the first and second sleeve edges 1202, 1204 together. In one example, the fastener 1206 is itself an inflation control feature and is configured to gradually open during inflation of the aerostat envelope 100 thereby allowing the tail portion 104 to gradually inflate from the open mouth 1208 toward the sleeve end 1210 to constrain the fins 1100, 1102, 1104 during inflation. In one example, the tail sleeve 1200 including, for instance, the rolling mouth 1208 or another inflation control feature such as the fastener 1206 as described above is sized and shaped to ensure that the aerostat envelope 100 maintains a desired pressure during inflation. Stated another way, the tail portion 104 including the fins 1100, 1102,1104 is not able to immediately inflate and is instead gradually inflated according to opening of the inflation control feature, such as the rolling mouth 1208. Additionally, a tail sleeve 1200 including the inflation control feature substantially prevents the whipping of portions of the fins 1100, 1102, 1104 during inclement weather such as high winds. Instead, the fins 1100, 1102, 1104 are gradually inflated from a fore most portion toward an aft most portion of each fin 1100, 1102, 1104.). During inflation, the fins 1100, 1102, 1104 are constrained from moving (e.g., while partially inflated) by the tail sleeve 1200 until fully inflated and accordingly released from the tail sleeve.

Referring now to FIG. 13, the tail sleeve 1200 including the rolling mouth 1208 is shown positioned around the tail portion 104, with the tail portion, for example, in the final folded configuration 1124 previously shown in FIG. 11E. In the example shown in FIG. 13, a mouth roll 1212 is provided to assist in gradual rolling of the rolling mouth 1208 from the fore portion toward the sleeve end 1210, for instance, during inflation of the aerostat envelope 100. That is to say, in one example, an optional mouth roll 1212, such as a fold of the material of the tail sleeve 1200, is folded backward along the tail sleeve 1200 to assist the tail portion 104 during inflation to gradually roll backward along itself as the first, second, and third fins 1100, 1102, 1104 are gradually inflated from a fore to an aft direction. In another example, the tail sleeve 1200 is provided without the mouth roll 1212 and by itself is able to roll backward from the rolling mouth 1208 toward the sleeve end 1210 while at the same time controlling inflation of the first, second, and third fins 1100, 1102, 1104 in the fore to aft directions.

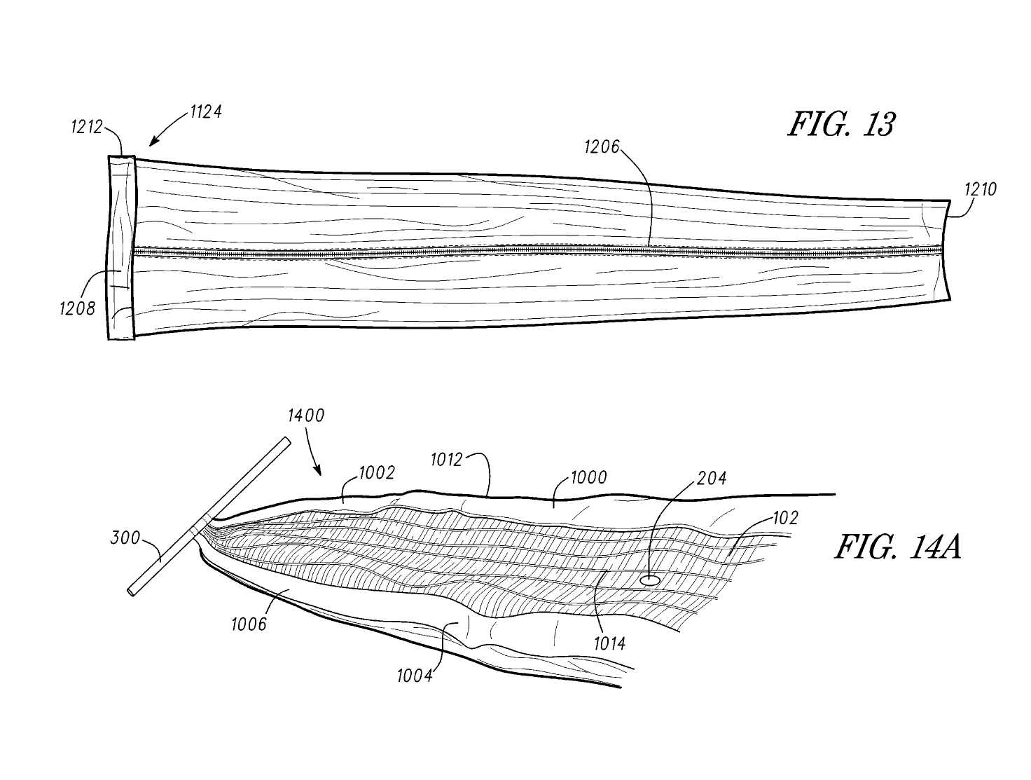

FIGS. 14A and 14B show views of the folded envelope 1000 in a configuration ready for rolling with the spindles 300 of each of the fore and aft envelope housings 126, 128. Referring first to FIG. 14A, the folded fore portion 1006 is shown with the left and right cores 1002, 1004 in substantially opposite positions relative to that shown in FIG. 10A. The left and right cores 1002, 1004 are on opposite sides because the folded envelope 1000 is inverted relative to the configuration shown in FIG. 10B. That is to say, the folded envelope lower surface 1014 is on top of the folded envelope upper surface 1012. The inflation port 204 is shown upwardly. At the far end of the folded fore portion 1006, the spindle 300 of the fore envelope housing 126 is shown rolled around a portion of the folded fore portion (e.g., a nose of the envelope 100).

In a similar manner, the folded aft portion 1008 is shown in FIG. 14B with the folded envelope lower surface 1014 again facing upward while the folded envelope upper surface 1012 is facing downward. The left and right cores 1002, 1004 are again positioned conversely relative to the position shown in FIGS. 10A and 10B. The tail portion 104 is shown in the final folded configuration 1124 previously shown in the right most view of FIG. 11D. The tail sleeve 1200 is positioned around the folded tail portion 104. As shown, at the end of the folded aft portion 1008 the spindle 300 for the aft envelope housing 128 is shown at the folded tail portion 104. From the orientation shown in FIGS. 14A and 14B the folded fore and aft portions 1006, 1008 will be respectively wrapped around the spindles 300 toward the center of the aerostat envelope 1000. The inflation port 204 will remain exposed for eventual coupling with the gas tubing 202 shown in FIG. 2A, for instance, by way of the quick disconnect coupling 206 (shown in FIG. 2A).

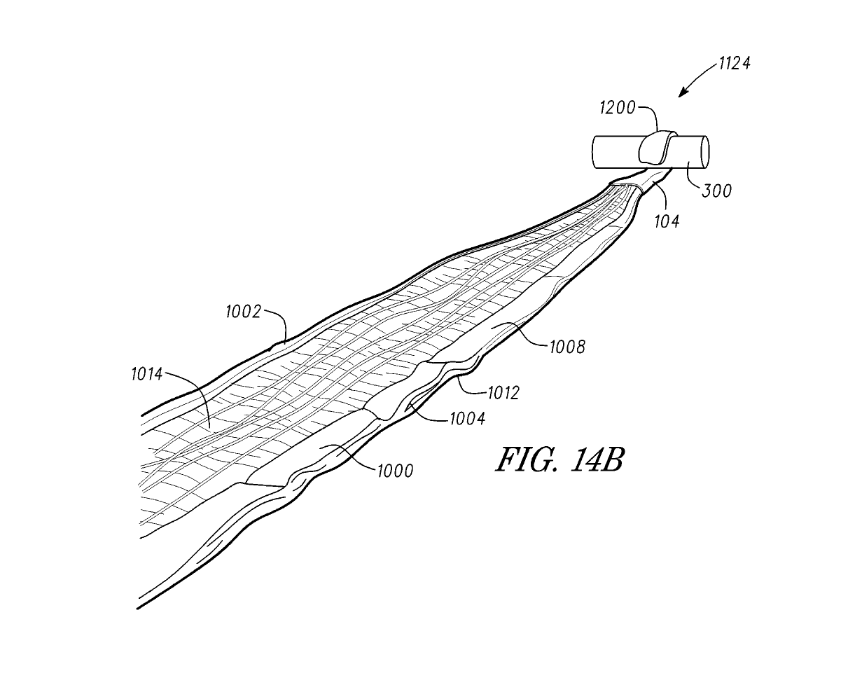

As shown in FIG. 15, the folded envelope 1000 is wrapped around each of the spindles 300 for the respective fore and aft envelope housings 126, 128. For instance, each of the folded fore portion 1006 and folded aft portion is wrapped around respective spindles 300. In this configuration, the folded envelope 1000 is in the configuration shown, for instance, in FIG. 10B with the folded envelope upper surface 1012 above the folded envelope lower surface 1014. The inflation port 204 previously shown in FIG. 14A is now pointed downward in an exposed position for coupling with the gas tubing 202. In the configuration shown in FIG. 15, the folded envelope 1000 with the spindles 300 having the corresponding folded fore portion 1006 and folded aft portion 1008 wrapped therearound is ready for installation in the respective fore and aft envelope housings 126, 128 shown in FIGS. 2A and 2B.

As previously described, in one example, the spindles 300 with the folded envelope 1000 are installed into the respective envelope housings 126, 128 with a portion of the folded envelope 1000 extending across the payload recess 226 shown in FIG. 2B. In one example, prior to installation of the folded envelope 1000 into the fore and aft envelope housings 126, 128 of the aerostat deployment system 122, the gondola 114, including the payload, is installed on the aerostat deployment system 122. For instance, the gondola 114 is removably coupled with one or more of the housing bodies 220, shown in FIG. 2B. After installation of the gondola 114 and installation of the folded envelope 1000, the flying lines 116 of the folded envelope 1000 are thereafter coupled with the gondola 114 and, in at least one example, coupled with a tether 118 in the hoist system 120, shown in FIG. 1. After installation of the folded envelope 1000 into the aerostat deployment system 122, the aerostat deployment system 122 including the aerostat envelope 1000 is substantially ready for deployment (e.g., inflation of the aerostat envelope into the configuration shown in FIG. 1).

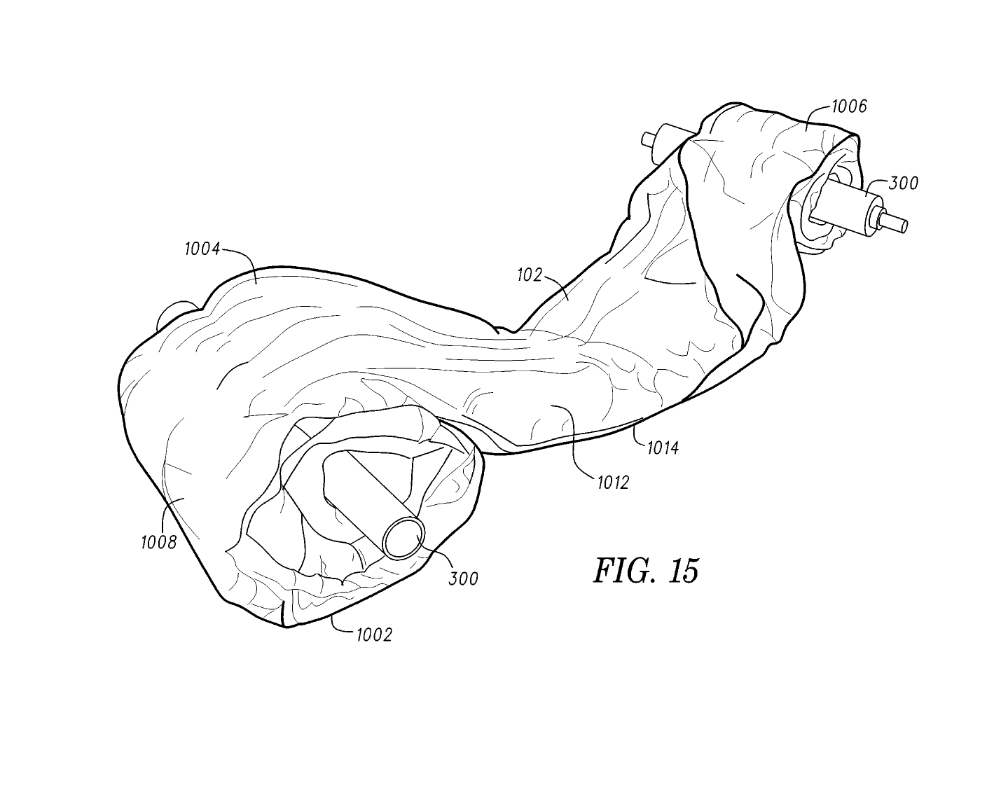

Referring to FIGS. 16, 17, and 18, the aerostat envelope 100 is shown in a plurality of intermediate inflated configurations begun from the storage configuration provided in FIGS. 2A and 2B and ending in the deployed configuration shown in FIG. 1. As previously described, the aerostat deployment system 122 is configured to control and meter the deployment of the aerostat envelope 100, for instance, fore and aft portions 106, 108 to ensure the aft portion 108 of the aerostat envelope 100 is inflated prior to (or preferentially to) the inflation of the fore portion 106. Additionally, the aerostat deployment system 122, as described herein, is configured to control the inflation of both the fore and aft portions 106, 108, For example, the aerostat deployment system 122 ensures the inflation pressure within the aerostat envelope 100 is maintained below a threshold pressure as the aerostat envelope 100 inflates and more of the aerostat envelope becomes available for inflation (e.g., the available inflatable volume of the aerostat envelope increases during inflation).

Referring first to FIG. 16, the aerostat envelope 100 including the hull 102 is shown in a first intermediate configuration with the aft portion 108 partially inflated from the aft envelope housing 128. In an example, the aft portion 108 is partially inflated or fully inflated prior to initiating inflation of the fore portion 106. Further, in an example, the fore and aft portions 106, 108 are inflated substantially simultaneously. As shown, the fore envelope housing 126 including, for instance, one or more brake assemblies, such as the brake assembly 224 shown in FIG. 2B, retains the fore portion 106 of the aerostat envelope 100 therein. In contrast, the aft envelope housing 128 including, for instance, a brake assembly 224 therein, again shown in FIG. 2B, is operated to allow the aft portion 108 of the aerostat envelope 100 to unroll from the spindle 300 and accordingly inflate as inflation gas is provided through the gas tubing 202, shown in FIG. 16. As previously described, the gas tubing 202 is coupled with an inflation port 204, for instance, by way of a quick disconnect coupling 206, as shown in FIG. 2A. In one example, the gas tubing 202 is coupled with a portion of the hull 102 extending between the fore and aft envelope housings 126, 128, for instance at the payload recess 226 of the aerostat deployment system 122.

Optionally, and as shown in FIG. 16, a portion of the tail portion 104, for instance one of the fins 110, is shown partially deployed from the aft portion 108. As shown and described herein, a tail sleeve 1200 is provided around at least a portion of the tail portion 104 to constrain and control inflation of the fins 1100.

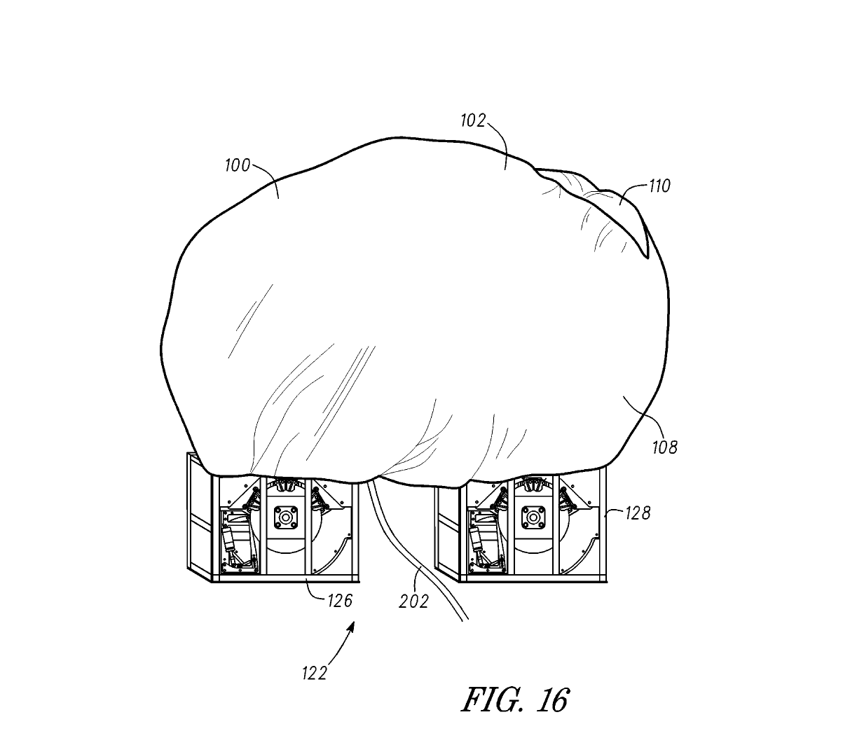

FIG. 17 shows the aerostat envelope 100 at a second intermediate inflated configuration. As shown, the aft portion 108 of the aerostat envelope 100 is fully released from the aft envelope housing 128. The fore portion 106 of the aerostat envelope 100 remains constrained and contained within the fore envelope housing 126. Referring again to the aft portion 108 of the aerostat envelope 100, the tail portion 104 is shown substantially deployed relative to the remainder of the aerostat envelope 100, such as the fore portion 106. As shown in phantom lines, the tail sleeve 1200 is shown partially around one or more of the fins 110. The remainder of the fins 110 are presented outside of the tail sleeve 1200. As previously described, the tail sleeve 1200, in one example, includes an inflation control feature, such as rolling mouth 1208 shown in FIG. 13. The rolling mouth or mouth of the tail sleeve 1200 gradually rolls down the length of the tail sleeve 1200 as inflation gas is provided to the aerostat envelop 100 thereby allowing the fins 110 to inflate from the fore to the aft as shown in FIG. 17. That is to say, the fore portion of each of the fins 110 inflates preferentially prior to inflation of the aft portions of the fins 110. The aerostat envelope in the second intermediate configuration shown in FIG. 17 provides an aerodynamic profile that is more easily manageable than inflation of the aerostat envelope 100, for instance, in an uncontrolled fashion where the fore portion 106 is inflated at the same time relative to inflation of the aft portion 108 (including, in one example, the tail portion 104).

In another example, additional control features are provided to the fins 110 including, for instance, the fin reefing patches 1106, shown in FIGS. 11A and 11B. The fin reefing patches 1106 as shown in FIG. 11B constrain deployment of the first, second, and third fins 1100, 1102, 1104 (corresponding to the fins 110 described herein) and thereby ensure the fins in cooperation, for instance, with the tail sleeve 1200 are able to deploy in a controlled fashion with each of the fins deploying in a radial manner relative to the remainder of the tail portion 104 (e.g., the portion of the hull 102 in communication with the first, second, and third fins 1100, 1102, 1104).

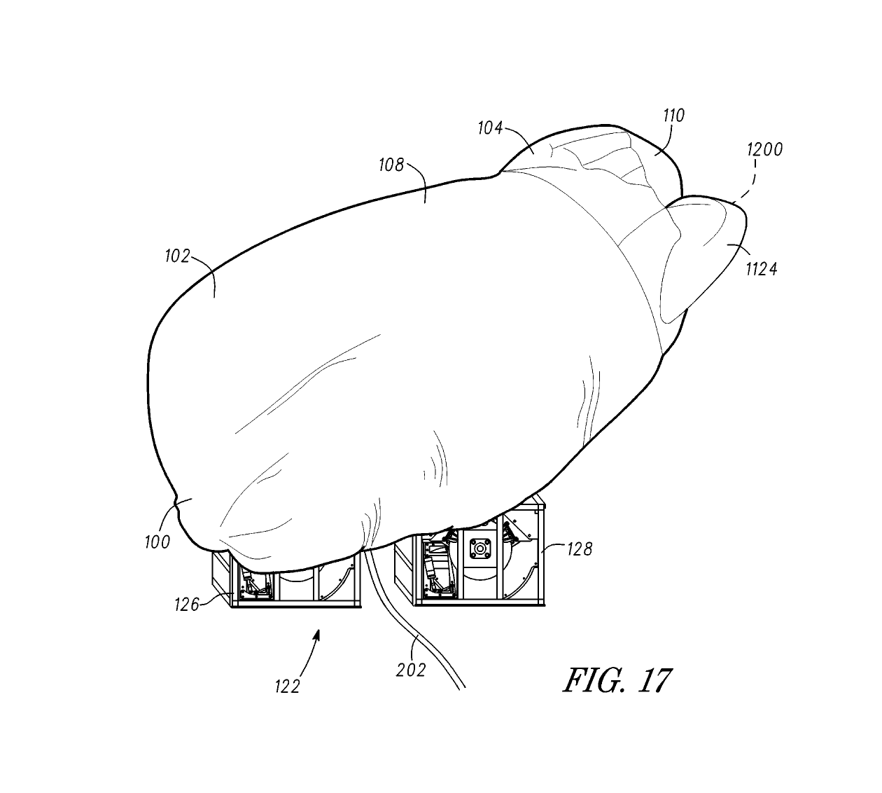

FIG. 18 shows the aerostat envelope 100 including the hull 102 in a third intermediate inflated configuration. As shown, the aft portion 108 is fully inflated with the fins 110 in a deployed state and fully inflated relative to the configuration shown in FIG. 17. Additionally, one or more flying lines 116 coupled with the hull 102 are shown (and correspondingly coupled with the retention winches 132 shown in FIG. 1). The fore portion 106 of the aerostat envelope 100 has been released in this configuration to allow for inflation of the fore portion 106. That is, after inflation of the tail and aft portions 104, 108 the fore portion 106 is released by the fore envelope housing 126, for instance the brake assembly 224 therein (e.g., the pinch roller assembly 308 or brake pad assembly 304). As shown in FIG. 18, the fore portion 106 is gradually inflated relative to the remainder of the aerostat envelope 100.

In one example, one or more of the brake assemblies 224 associated with each of the fore and aft envelope housings 126, 128 cooperate to meter out the deployment of the aerostat envelope 100 in the folded configurations, described herein, to ensure pressure within the aerostat envelope 100, such as 2 inches of water column (IWC) is substantially maintained throughout inflation of the aerostat envelope 100. For example, the brake assemblies 224 are operated with a releasing threshold and a retention threshold. The releasing threshold is achieved when the pressure within the aerostat envelope 100 reaches or exceeds 2 IWC and the retaining threshold is met as the pressure within the aerostat envelope 100 drops below some pressure value such as 1.5 IWC (corresponding to the increase of volume of the aerostat envelope 100 and constant or near constant infusion of inflation gas from the inflation gas source 200 the pressure within the aerostat envelope 100 during the inflation procedure will rise and drop). In one example, one or more of the brake assemblies 224 associated with the fore and aft envelop housings 126, 128 are operated according to pressure measurements with the aerostat envelope 100. As the releasing pressure threshold is met the brake assemblies 224 are released, thereby allowing for additional distribution of the folded aerostat envelope 100 from one or both of the fore and aft envelope housings 126, 128. As the retaining pressure threshold is met, for instance by a drop in pressure in the aerostat envelope 100, one or both of the braking assemblies 224 is correspondingly engaged to thereby substantially prevent the further distribution of material of the aerostat envelope in the folded configuration from one or both of the fore or aft envelope housings 126, 128 until the pressure rises. The pressure within the envelope 100 is thereby maintained in a desired range, for instance 1.5 to 2 IWC, and the skin stress of the envelope material is correspondingly controlled within acceptable parameters to prevent damage to the envelope.

After the aerostat envelope 100 is inflated into a fully inflated configuration, the aerostat envelope 100 appears substantially as depicted in FIG. 1. As shown, the aerostat envelope 100 is shown fully inflated with the flying lines extending from underneath the aerostat envelope 100 to the gondola 114, a tether 118, and a hoist system 120. The control lines 130 similarly extend from the aerostat envelope 100 and are coupled with the retention winches 132. In this configuration the aerostat envelope 100 is ready for deployment, but is still coupled with the aerostat deployment system 122 by way of the control lines 130 coupled with the retention winches 132. The aerostat deployment system 122 thereby provides an anchor to the aerostat envelope 100 that substantially prevents the free elevation of the aerostat envelope 100 without first decoupling the control lines 130 from the retention winches 132. When deployment of the aerostat envelope 100 is desired, the retention winches 132 are operated, for instance, by manual operation with an operator or electronic disengagement by way of the programmed logic controller contained within the control enclosure 212, shown in FIG. 2A, to release the control lines 130 and thereby allow the aerostat envelope 100 to be deployed for instance by way of the hoist system 120 and the tether 118.

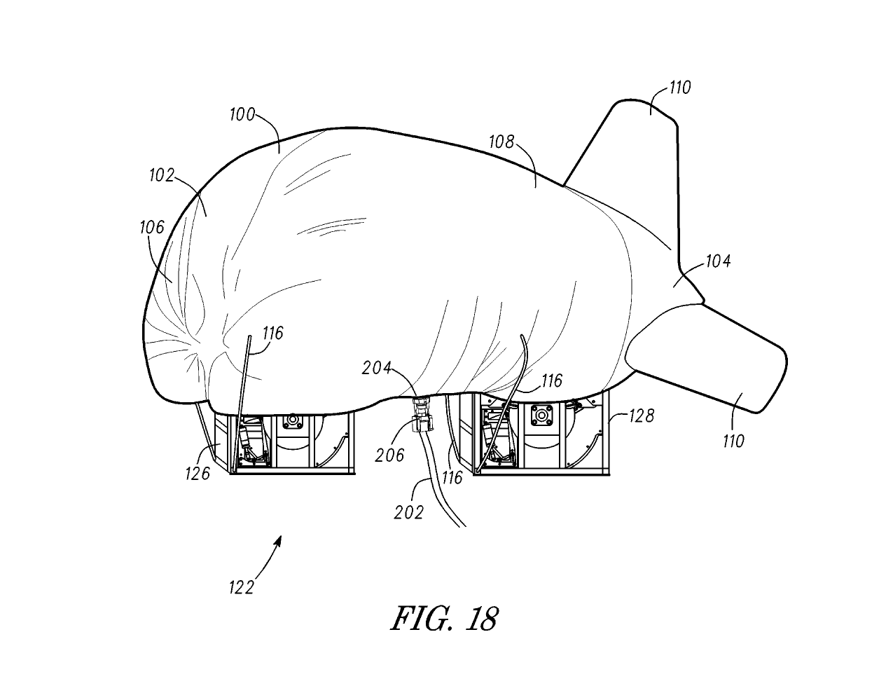

FIG. 19 shows a block diagram illustrating one example of a method 1900 for deploying an aerostat with an aerostat deployment system, such as the aerostat deployment system 122 described herein. In describing the method 1900 reference is made to features and elements previously described herein including numbered references. Where convenient, numbered elements provided within the description of the method 1900 are not intended to be limiting, instead numbered references are provided for convenience and further include any similar features described herein, as well as their equivalents. At 1902, the method 1900 includes inflating an aerostat envelope 100 wherein a payload (e.g., a gondola 114) is coupled with the aerostat envelope prior to inflation. For instance, as previously described herein, the gondola 114 includes one or more sensors such as the first and second sensors 600, 604, shown in FIG. 6. The gondola 114 in another example includes a gondola frame 606 preinstalled with the aerostat envelope 100 and installed with the aerostat deployment system 122 to provide a unitary deployment system configured to inflate the aerostat envelope 100 into the configuration shown in FIG. 1 with the gondola 114 preinstalled and accordingly suspended from the aerostat envelope 100 upon deployment.

At 1904, a folded aft portion 1008 (see FIGS. 10A, 10B) of the aerostat envelope 100 is deployed from an aft envelope housing 128 as the aft portion 108 is inflated. That is to say, as previously described herein, the folded aft portion 10o8 is contained and housed within the aft envelope housing 128. As the folded aft portion 1008 is deployed, for instance through operation of one or more brake assemblies 224, including, but not limited to, a disc brake assembly, a pinch roller, and the like, the folded aft portion 1008 is inflated into the aft portion, as shown in FIGS. 16 and 17.

At 1906, the folded fore portion 1006 of the folded envelope 1000 is deployed from a fore envelope housing 126. The fore portion 106 is inflated by the introduction of an inflation gas from an inflation gas source 200 (see FIG. 2A). Deployment of the folded fore portion 1006 of the aerostat envelope 1000 begins after the aft portion 108 is at least partially inflated (for instance, from the folded aft portion 1008 contained within the aft envelope housing 128). As previously described herein, deployment of the folded fore portion 1006 after deployment of the folded aft portion 1008 (see FIGS. 16, 17, and 18) ensures an aerodynamic profile is provided for the aerostat envelope 100 while partially inflated. Stated another way, the tail portion such as the tail portion 104 shown in FIG. 1 and further shown in FIG. 18, provides an aerodynamic profile to the aerostat envelope 100 and allows the aerostat envelope 100 to be easily managed (by a small number of operators), for instance during inclement weather including high winds.

At 1908, the method 1900 includes suspending the payload, such as a gondola 114 including one or more sensors thereon from the aerostat envelope 100 as one or more of the aft or fore portions 106, 108 are inflated. For instance, as shown in FIG. 1, in the deployed condition the aerostat envelope 100 is shown coupled to the aerostat deployment system 122 while at the same time the gondola 114 including the payload thereon is suspended below the aerostat envelope 100. The gondola 114 is preinstalled with the aerostat envelope 100. The gondola 114 is thereby suspended in the configuration shown in FIG. 1 without installation of the gondola 114, for instance after inflation of the aerostat envelope 100.

Several options for the method 1900 are provided below. In one example, inflating the aerostat envelope 100 includes inflating the folded aft portion 1008 having a folded tail portion, such as the tail portion having the configuration 1124, previously described herein, and longitudinally constraining inflation of the folded tail portion to inflate in a fore to an aft progression. For instance, as shown in FIGS. 12A, 12B, and 13, a tail sleeve 1200, in one example, is wrapped around the folded tail portion and as the folded tail portion is deployed, for instance with inflation of the folded aft portion 1008, the fins 110 are gradually deployed from the fore to the aft portion of the tail portion 104, shown in FIG. 1. As shown in FIG. 17, the fins 110 are provided in a partially inflated configuration, wherein the fore portion of the fins 110 is biased to inflate first while the aft portion of the fins remain contained within the tail sleeve 1200. As described herein, in one example the tail sleeve includes an inflation control feature such as a rolling mouth 1208 sized and shaped to gradually roll back on the tail sleeve 1200 and thereby allow the folded tail portion 104 to gradually deploy the fins 110 in a fore to aft manner.

In another example, the method 1900 further includes laterally constraining inflation of two or more of the fins such as the first, second, and third fins 1100, 1102, 1104 with fin reefing patches 1106 coupled between at least two of the fins. In one example, the fin reefing patches 1106 include cords, such as a reefing line having a reefing line first end and a reefing line second end, each of the ends coupled with corresponding fins and a stored reefing line 1112 contained within a patch substrate 1114 having line retaining features 1116. In one example the reefing line is a cord retained within a line retaining feature 1116, such as a cord housing including loops of the patch substrate material that are configured to gradually release the reefing line during inflation of the tail portion 104.

In yet another example, deploying the folded aft portion 1008 from the aft envelope housing 128 includes unrolling the folded aft portion 1008 from an aft spindle 300 rotatably coupled with the aft envelope housing including the housing body 220, shown in FIG. 2B. In a similar manner, deploying the folded fore portion 1006 from the fore envelope housing 126 includes unrolling the folded fore portion from a fore spindle 300 rotatably coupled with the fore envelope housing including the housing body 220, also shown in FIG. 2B. Optionally, deploying one or more of the folded fore or folded aft portions 1006, 1008 from the respective envelope housings 126, 128 includes controlling deployment of one or more of the folded fore or aft portions 1006, 1008 with one or more brakes, such as the brake assemblies 224 (including, but not limited to, disc brakes, pinch roller assemblies, or the like) coupled with one or more of the aft or fore spindles 300. As previously described herein, in one example the pinch roller assembly 308, including the pinch roller 316, operates in combination with the brake pad assemblies 304 provided in one or more of the fore or aft envelope housing 126, 128 to allow and prevent rotation of the spindle 300 while at the same time the pinch roller assembly 308 ensures the aerostat envelope 100 in the folded configuration remains in a flat consistent shape around the spindle 300 until the aerostat envelope 100 is delivered from between the pinch roller 316 and the spindle 300.

In another example, the method 1900 further includes measuring of pressure within the aerostat envelope 100 during the inflation procedure. For instance, in one example, pressure tubing 216 extends from a programmed logic controller (PLC) within a control enclosure 212 to a pressure sensor provided within the aerostat envelope 100. The PLC is thereby able to measure the pressure within the aerostat envelope 100 during deployment of the envelope 100. In another example, the method 1900 includes controlling deployment of one or more of the folded fore or aft portions 1006, 1008 or inflation of the aerostat envelope 100 with a controller such as the PLC according to the pressure measured within the aerostat envelope 100.

In one example, the method 1900 includes interrupting inflation of the aerostat envelope with the controller such as the PLC within the control enclosure 212, for instance by interrupting the flow of gas from the inflation gas source 200 to the aerostat envelope 100 with an intervening flow valve. In yet another example, the method 1900 further includes disconnecting the gas tubing 202 from an inflation port such as the inflation port 204, shown in FIG. 2A, with a controller, such as the PLC according to an inflated pressure threshold within the aerostat envelope 100. For instance, where a pressure is reached and maintained within the aerostat envelope 100, for instance 2 IWC, the PLC is configured to provide or interrupt the pressurization of a fluid for instance through the coupling air line 208 to the quick disconnect coupling 206. As described herein, the quick disconnect coupling 206 thereby separates the gas tubing 202 from the inflation port 204 by operation of one or more actuators, such as the actuators 808 shown in FIG. 8.

In another example, the method 1900 further includes anchoring the inflated aerostat envelope 100, such as the aerostat envelope shown in FIG. 1, with one or more control lines 130 extending between the support frame 124 of the aerostat deployment system 122 and the inflated aerostat envelope 100. As shown, for instance in FIG. 1, the payload, such as the gondola 114, is positioned between the inflated aerostat envelope 100 and the support frame 124. As shown, the gondola 114 is, in one example, coupled with the aerostat envelope by way of flying lines 116 that suspend the gondola 114 below the inflated aerostat envelope 100. The control lines 130 are positioned at locations around the gondola 114 and the flying lines 116 to provide a stable support that anchors the envelope 100 in place until deployment (e.g., to a desired elevation) is desired. Accordingly, in the configuration shown in FIG. 1, the aerostat envelope 100, while fully inflated, is anchored to the aerostat deployment system 122 and the support frame 124 provides a weighted base to the aerostat envelope 100 that improves the ability to manage the aerostat envelope 100 prior to deployment, for instance with the hoist system 120 and the tether 118. In one example, the programmed logic controller associated with a control enclosure 212 is operated to release the control lines 130, for instance by operation of the retaining winches 132 shown in FIG. 2A. Release of the retaining winches 132 allows the control lines 130 to freely play out from the retention winches 132 and allows the aerostat envelope 100 to rise relative to the aerostat deployment system 122 according to operation of the hoist system 120. Stated another way, the PLC transitions from the fully inflated configuration, shown in FIG. 1, to a deployed or ascent mode where the hoist system 120 is operated to gradually play out the tether 118 and allow the aerostat envelope 100 to ascend to a desire altitude with the gondola 114 suspended there beneath.

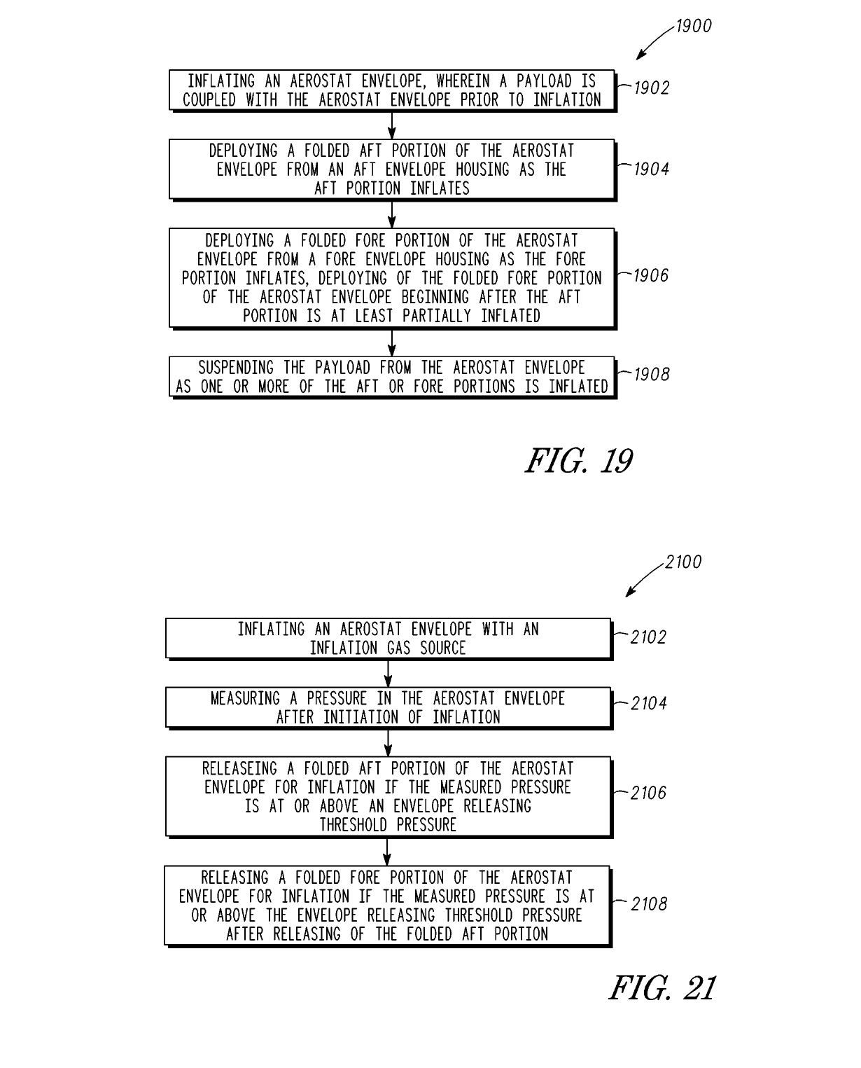

FIG. 20 shows one schematic diagram of an example of a control and instrument system for the aerostat deployment system, such as the aerostat deployment system 122, shown in FIG. 1. As shown in FIG. 20, one or more of the components, previously described and shown in the Figures, is provided in schematic form to show the coupling of the control system (e.g., housed in the control enclosure 212) with each of the various components of the aerostat deployment system 122. As shown, the aerostat deployment system 122 includes the fore and aft envelope housings 126, 128. Each of the housings as previously describe includes a spindle 300 rotatably mounted within the housing. The respective fore and aft portions 106, 108 are wrapped around the corresponding spindles 300 of each of the fore and aft envelope housings 126, 128. As shown in FIG. 20, the aerostat envelope 100 extends between each of the fore and aft envelope housings 126, 128, for instance, across a payload recess 226 shown in FIG. 2B. As further shown in FIG. 20, the aerostat envelope 100 is coupled with the quick disconnect coupling 206 correspondingly coupled to the inflation gas source 200 by the gas tubing 202 with a quick disconnect coupling 206. As described herein, inflation gas source 200 provides a source of inflation gas delivered to the aerostat envelope 100 to inflate the aerostat envelope, for instance, through operation of the aerostat deployment system 122.

Referring again to FIG. 20, the control enclosure 212, previously shown in FIG. 2A, is provided in schematic form. In one example, the control enclosure 212 includes a programmable logic controller (PLC) 2002, the PLC includes a memory, a processor, and other corresponding components needed to operate one or more of the components of the aerostat deployment system 122, as described herein. For instance, in one example, the control enclosure 212 includes a pressure module 2000 and a graphic user interface (GUI) 2004. The GUI 2004 allows for input and output of information, for instance, through a display and input device (e.g., touchscreen, key pad, keyboard, or the like) about the status of the aerostat deployment system 122 prior to initiation of deployment of the aerostat envelope 100, as well as monitoring of the aerostat envelope 100, for instance, during deployment (inflation) of the aerostat envelope by way of inflation with the inflation gas source 200. The pressure module 2000, as shown in FIG. 20 is coupled with pressure tubing 216 with a pressure sensor 2001 coupled with the aerostat envelope 100. The pressure module 2000 is able, in combination with the pressure sensor 2001, to monitor the pressure within the aerostat envelope 100 during inflation of the aerostat envelope 100. The pressure module 2000 is in communication with the control module 2002 to accordingly facilitate control of inflation of the aerostat envelope 100 according to the pressure measurements made with the pressure sensor 2001.

As further shown in FIG. 20, the PLC 2002 is coupled with one or more components of the aerostat deployment system 122. For instance, the PLC 2002 is coupled with the compressor 214 with a compressor control coupling 2018, as shown in FIG. 20. The PLC 2002 is thereby able to control the operation of the compressor 214. Additionally, in another example, the PLC 2002 is coupled by way of an air manifold control coupling 2010 with the air manifold distributor 2008, shown in FIG. 20. As described herein, the air manifold distributor 2008 selectively distributes pressurized air from the air compressor 214 throughout the aerostat deployment system 122, for instance, to one or more brake assemblies 224 associated with the fore and aft envelope housings 126, 128. In another example, the air manifold distributor 2008 is in another example coupled, by way of envelope housing air lines 210, with the pinch roller assemblies 308. The air manifold distributor 2008, in combination with control by the PLC 2002, is thereby able to selectively deliver or cease delivery of air to one or more of the brake assemblies 224 and the pinch roller assemblies 308 to initiate and control operation, for instance, rotation of the spindles 300 and corresponding deployment of the aerostat envelope 100 from one or both of the fore and aft envelope housings 126, 128.

Additionally, as shown in FIG. 20, in one example, the air manifold distributor 2008 is also coupled with the quick disconnect coupling 206, for instance, by the coupling airline 208. The air manifold distributor 2008 is thereby able, through control provided by the PLC 2002, able to actuate the quick disconnect coupling 206 and thereby initiate disconnection of the inflation gas mainline 2014 from the aerostat envelope 100, for instance, after full inflation of the aerostat envelope 100.

In another example, the PLC 2002 is coupled, by way of an inflation gas manifold control coupling 2016, with an inflation gas manifold distributor 2012, shown in FIG. 20. The inflation gas manifold distributor 2012 consolidates the gas delivery of a plurality of tanks associated with the inflation gas source 200 into a single source of gas for the inflation gas mainline 2014 for subsequent delivery to the aerostat envelope 100. The inflation gas manifold control coupling 2016 thereby allows the programmed logic controller 2002 to deliver or interrupt delivery of pressurized inflation gas, such as helium, through the inflation gas mainline 2014 to the aerostat envelope 100.

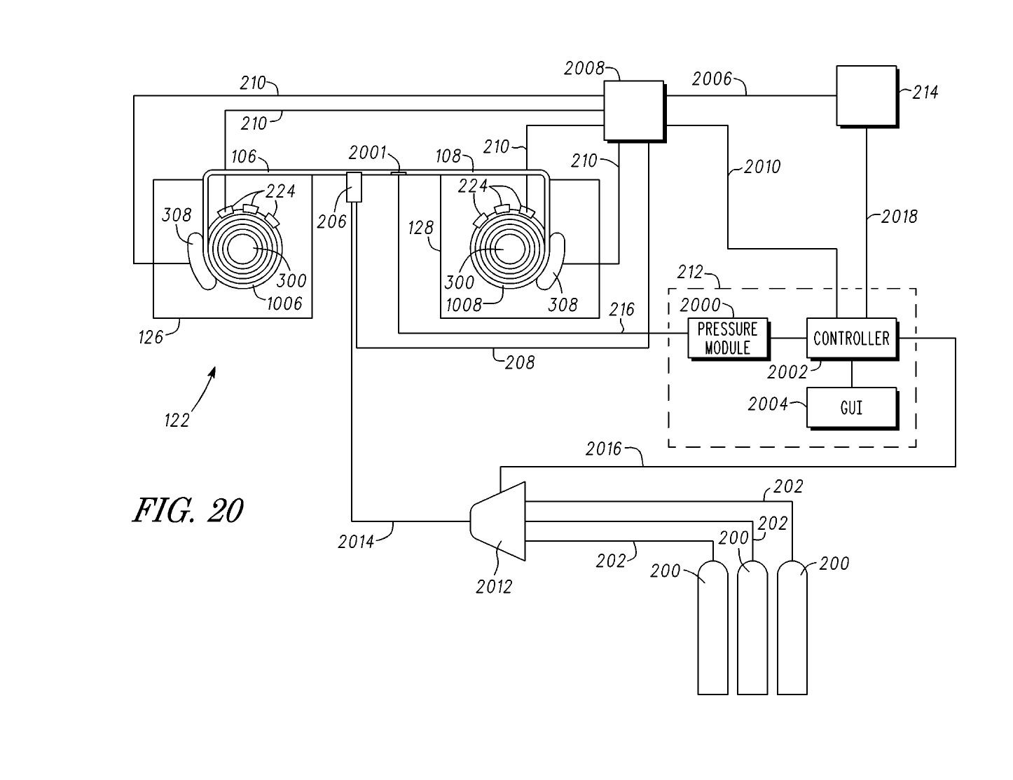

FIG. 21 shows a block diagram illustrating one example of a method 2100 for controlling deployment of an aerostat envelope, such as the aerostat envelope 100 previously shown in FIG. 1. In describing the method 2100, reference is made to features and elements previously described herein including numbered references. Where convenient, numbered elements provided within the description of the method 2100 are not intended to be limiting. Instead, numbered references are provided for convenience and further include any similar features described herein as well as their equivalents. At 2102, the method 2100 includes inflating an aerostat envelope 100 with an inflation gas source, such as the inflation gas source 200, shown in FIG. 2A. In one example, initiation of inflation is provided by the PLC 2002, shown in the control enclosure 212 in FIG. 20. For instance, the PLC 2002 is coupled, by way of an inflation gas manifold control coupling 2016, with an inflation gas manifold distributor 2012. An operator is thereby able to initiate inflation of the aerostat envelope 100, for instance, by inputting an initiation instruction with the graphic user interface 2004. The PLC 2002 thereafter initiates inflation by opening one or more valves, for instance, a valve provided in the inflation gas manifold distributor 2012.

At 2014, the method 2100 includes measuring a pressure in the aerostat envelope 100 after initiation of inflation. In one example and as shown in FIG. 20, a pressure sensor 2001 is coupled with a pressure module 2000 associated with the control enclosure 212. The pressure module 2000 is in communication with the PLC 2002. The PLC 2002, in combination with the pressure module 2000, is thereby able to monitor pressure measurements made by the pressure sensor 2001. As will be described in further detail below, the measurement of pressure within the aerostat envelope 100 allows for the release and subsequent engagement and holding of the aerostat envelope 100 during an inflation procedure, for instance, according to pressure measurements made with the pressure sensor 2001.

At 2106, a folded aft portion 1008 (see FIGS. 10A and 10B) of the aerostat envelope 100 is released for inflation if the measured pressure is at or above an envelope releasing threshold pressure, for instance, 2 IWC. For example, 2106 includes optionally releasing the folded aft portion by way of operation of the brake assembly 224, shown in FIG. 20, associated with the aft envelope housing 128. In one example, the PLC 2002 provides an instruction to the air manifold distributor 2008 according to pressure measurements provided by the pressure module 2000 in combination with the pressure sensor 2001. When the pressure within the aerostat envelope 100 is at or above an envelope releasing threshold pressure such as 2 IWC the brake assembly 224 is released according to operation of the air manifold distributor 2008 controlled by the PLC 2002. Release of the brake assembly 224 allows the spindle 300 to rotate. With the introduction of pressurized gas to the aerostat envelope 100 the spindle 300 rotates passively allowing the aerostat envelope 100, for instance, the aft portion to deploy from the aft envelope housing 128.

At 2108, similarly a folded fore portion 1006 of the aerostat envelope 100 (the folded envelope 1000) is released if the measured pressure is at or above an envelope releasing threshold pressure (e.g., 2 IWC) after releasing of the folded aft portion 1008. Stated another way, after the folded aft portion 1008 is deployed either partially or fully from the aft envelope housing 128 and pressure continues to rise within the aerostat envelope 100 the PLC 2002 operates, in one example, the air manifold distributor 2008 to release the brake assembly 224 from the spindle 300 associated with the fore envelope housing 126. The folded fore portion 1006 is thereby passively allowed to inflate as the envelope 100 is inflated with the introduction of additional pressurized gas from the inflation gas source 200. Optionally, the PLC 2002 is similarly capable of operating one or both of the pinch roller assemblies 308 associated with the fore and aft envelope housings 126, 128. For instance, the control module 2002 operates the pinch roller assemblies 308 to meter the deployment of the folded fore and aft portions 1006, 1008 from the housings 126, 128.

As previously described above, the method 2100 includes releasing the folded fore portion 1006 after release of the folded aft portion 1008. In one example, the folded fore portion is released after the folded aft portion 1008 according to operation of the PLC 2002 operated in cooperation with the pressure module 2000. For instance, as previously described above, the pressure module 2000 is able to monitor the pressure within the aerostat envelope 100 during the inflation of the aerostat envelope. As gas is introduced to the aerostat envelope 100, the aft envelope housing 128 allows for the passive deployment (rotation of the spindle 300 and corresponding unrolling of the folded aft portion 1008) according to pressure measurements made by the pressure sensor 2001. After the aerostat envelope 100 is completely released from the aft envelope housing 128, for instance, the aft portion 108 assumes an inflated or partially inflated configuration the pressure within the aerostat envelope 100 will continue to rise because there is no additional folded aft portion 1008 of the envelope to inflate. A repeated pressure measurement made by the pressure sensor 2001 and monitored by the pressure module 2000 indicating that the pressure within the aerostat envelope 100 is rising despite disengagement of the brake assemblies 224 from the spindle 300 of the aft envelope housing 128 alerts the PLC 2002 that the aft portion 108 of the aerostat envelope 100 is inflated and accordingly initiates disengagement of the brake assembly 224 from the spindle 300 of the fore envelope housing 126 and accordingly releases the folded fore portion 1006 for inflation.

Besides allowing for the continued inflation of the aerostat envelope 100, in one example, the PLC 2002 ensures the pressure within the aerostat envelope 100 remains between the envelope releasing threshold pressure and interrupting threshold pressure to maintain the pressure within the aerostat envelope 100 within a predictable range to inflate the envelope while also preventing pressure spikes and corresponding skin stress of the aerostat envelope 100. Additionally, the PLC 2002 further ensures the aerostat envelope 100 is not subject to under inflation and correspondingly avoids whipping of the aerostat envelope fabric, for instance, in high winds.

In one example, the pressure module 2000, while monitoring the pressure within the aerostat envelope 100, may detect that the pressure has fallen beneath an interrupting threshold pressure lower than the envelope releasing threshold pressure of, for instance, 2 IWC. For instance, if the pressure within the aerostat envelope 100 is measured at less than 1.5 IWC (an exemplary interrupting threshold pressure) the PLC 2002 operates one or both of the brake assemblies 224 to correspondingly interrupt deployment of the folded fore or aft portions 1006, 1008 of the folded envelope 1000. Accordingly, the continued introduction of pressurized gas from the inflation gas source 200 will continue to raise the pressure within the aerostat envelope 100 until the pressure monitored by the pressure module 2000 and detected by the pressure sensor 2001 rises above the interrupting threshold pressure of 1.5 IWC. When the pressure has risen above the envelope releasing threshold pressure, the PLC 2002, in communication with the pressure module 2000, will release one or both of the brake assemblies 224 and thereby allow the continued release of one or both of the folded fore and aft portions 1006, 1008 of the envelope.

In this manner, the PLC 2002, in cooperation with the various components of the aerostat deployment system 122, is able to provide measured and controlled deployment of the aerostat envelope 100 throughout the inflation process. As described above, the PLC ensures that the folded aft portion 1008 of the aerostat envelope 100 is inflated first (or preferentially) to provide an aerodynamic profile for the aerostat envelope 100. In one example, the folded fore portion 1006 is then inflated to finish inflation of the aerostat envelope 100. Additionally, the PLC 2002 and the other components, for instance, within the control enclosure 212, are able to tightly monitor the pressure within the aerostat envelope 100 and ensure that deployment of the aerostat envelope 100, for instance, the fore and aft folded portions 1006, 1008 proceeds in such a manner that the pressure within the aerostat envelope is maintained within predetermined pressure constraints, such as the releasing threshold pressure and an interrupting threshold pressure to rapidly inflate the envelope 100 to a desired pressure, while at the same time monitoring the pressure of the envelope and mitigating undesirable skin stress spikes to the envelope material.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An aerostat deployment system comprising:
a fore envelope housing with a folded fore portion of an inflatable aerostat envelope therein;
an aft envelope housing with a folded aft portion of the inflatable aerostat envelope therein;
a support frame interposed between the fore and aft envelope housings; and
a payload coupled with the inflatable aerostat envelope between the fore and aft envelope housings.

2. The aerostat deployment system of claim 1, wherein the fore envelope housing includes a rotatable fore spindle, and the folded fore portion is wrapped around the fore spindle.

3. The aerostat deployment system of claim 1, wherein the aft envelope housing includes a rotatable aft spindle, and the folded aft portion is wrapped around the aft spindle.

4. The aerostat deployment system of claim 1, wherein the folded aft portion of the inflatable aerostat envelope includes a folded tail portion.

5. The aerostat deployment system of claim 4 comprising a tail sleeve coupled around the folded tail portion, and the tail sleeve includes at least one inflation control feature configured to control inflation of the folded tail portion into a fore to aft inflation configuration.

6. The aerostat deployment system of claim 5, wherein the at least one inflation control feature includes a rolling mouth configured to roll from a fore portion of the tail portion to an aft portion of the tail portion as pressure in the fore portion meets or exceeds a threshold pressure.

7. The aerostat deployment system of claim 1, wherein the support frame includes a payload recess and the payload is retained within the payload recess between the fore and aft envelope housings.

8. The aerostat deployment system of claim 1, wherein at least one of the fore or aft envelope housings includes a rotatable spindle, and
at least one of the fore or aft envelope housings including the rotatable spindle includes a brake coupled with the rotatable spindle, the brake configured to control unrolling of the folded fore or aft portion from the rotatable spindle.

9. The aerostat deployment system of claim 8, wherein the brake includes at least one of a disk brake or a pinch roller.

10. The aerostat deployment system of claim 8 comprising a controller coupled with at least the brake, wherein the controller includes a brake control module configured to operate the brake and accordingly retain and meter the release of at least one of the folded fore or aft portions.

11. The aerostat deployment system of claim 10, wherein the controller includes a pressure sensing module configured to measure the pressure within the inflatable aerostat envelope, the pressure sensing module is in communication with the brake control module, and the pressure sensing module is configured to instruct the brake control module to retain or meter the release of at least one of the folded fore or aft portions according to the pressure measured.

12. A method for deploying an aerostat with an aerostat deployment system comprising:
inflating an aerostat envelope, wherein a payload is coupled with the aerostat envelope prior to inflation;
deploying a folded aft portion of the aerostat envelope from an aft envelope housing as the aft portion inflates;
deploying a folded fore portion of the aerostat envelope from a fore envelope housing as the fore portion inflates, deploying of the folded fore portion of the aerostat envelope beginning after the aft portion is at least partially inflated; and
suspending the payload from the aerostat envelope as at least one of the aft or fore portions is inflated.

13. The method of claim 12, wherein inflating the aerostat envelope includes inflating the folded aft portion having a folded tail portion and longitudinally constraining inflation of the folded tail portion to inflate from a fore portion to an aft portion of the folded tail portion.

14. The method of claim 13, wherein constraining inflation of the folded tail portion includes rolling a tail sleeve wrapped around the folded tail portion, the inflating folded tail portion rolling gradually from the fore to the aft of the tail portion.

15. The method of claim 13 comprising laterally constraining inflation of two or more fins of the folded tail portion with fin reefing patches coupled between at least two fins.

16. The method of claim 12, wherein deploying the folded aft portion from the aft envelope housing includes unrolling the folded aft portion from an aft spindle rotatably coupled with the aft envelope housing, and
deploying the folded fore portion from the fore envelope housing includes unrolling the folded fore portion from a fore spindle rotatably coupled with the fore envelope housing.

17. The method of claim 16, wherein deploying at least one of the folded aft or fore portions from the respective envelope housings includes controlling deployment of at least one of the folded aft or fore portions with at least one brake coupled with at least one of the aft or fore spindles.

18. The method of claim 12 comprising measuring a pressure within the aerostat envelope during inflation.

19. The method of claim 18 comprising controlling one or more of deployment of the folded fore or aft portions or inflation of the aerostat envelope with a controller according to the pressure measured within the aerostat envelope.

20. The method of claim 18 comprising interrupting inflation of the aerostat envelope with a controller according to the pressure measured within the aerostat envelope reaching an inflated pressure threshold.

21. The method of claim 18 comprising disconnecting gas tubing from an inflation port of the aerostat envelope with a controller according to an inflated pressure threshold.

22. The method of claim 12 comprising anchoring the inflated aerostat envelope with one or more control line extending between a support frame of the aerostat deployment system and the inflated aerostat envelope, wherein the payload is positioned between the inflated aerostat envelope and the support frame.

23. A method for packing an aerostat with an aerostat deployment system comprising:
folding a hull of an aerostat envelope into a folded core configuration;
folding a tail portion of the aerostat envelope into a folded tail configuration separate from folds of the hull in the folded core configuration;
positioning a folded fore portion of the aerostat envelope within a fore envelope housing;
positioning a folded aft portion of the aerostat envelope and the folded tail portion within an aft envelope housing, wherein a support frame couples the aft envelope housing with the fore envelope housing; and
coupling a payload with the inflatable aerostat envelope between the fore and aft envelope housings while the aft and fore portions are positioned within the fore and aft envelope housings.

24. The method of claim 23, wherein folding the hull of the aerostat envelope into the folded core configuration includes folding the hull into left and right cores, wherein each of the left and right cores is correspondingly positioned on either side of a longitudinal center line of the aerostat envelope.

25. The method of claim 23, wherein folding the hull of the aerostat envelope into the folded core configuration includes folding the hull with one or more accordion folds.

26. The method of claim 23, wherein folding the tail portion of the aerostat envelope into the folded tail configuration includes laying one or more tail fins of a plurality of tail fins over another tail fin of the plurality of tail fins from a tail stem to tail tips of each of the plurality of tail fins.

27. The method of claim 26 comprising coupling at least one fin reefing patch between two of the plurality of tail fins, the at least one fin reefing patch includes a cord within a cord housing, and the cord housing is configured to gradually release the cord during inflation of the tail portion.

28. The method of claim 23, wherein folding the tail portion of the aerostat envelope into the folded tail configuration includes folding the tail portion with at least one accordion folds, wherein the at least one accordion fold is parallel to a longitudinal center line of the aerostat envelope.

29. The method of claim 23 comprising wrapping the folded tail portion with a tail sleeve, the tail sleeve including at least one inflation control feature configured to control inflation of the folded tail portion into a fore to aft inflation configuration.

30. The method of claim 23 comprising wrapping the folded fore portion around a fore spindle, and wrapping the folded aft portion around an aft spindle.

31. The method of claim 30, wherein positioning the folded fore portion of the aerostat envelope within the fore envelope housing includes rotatably coupling the fore spindle with the fore envelope housing, and
wherein positioning the folded aft portion and the folded tail portion of the aerostat envelope within an aft envelope housing includes rotatably coupling the aft spindle with the aft envelope housing.

32. The method of claim 23 comprising coupling at least one control line with at least one retaining winch coupled with the aerostat deployment system, the at least one control line is coupled with the aerostat envelope.

33. The method of claim 23 comprising:
coupling a control module with at least one of the support frame, the fore envelope housing, or the aft envelope housing;
coupling the control module with an inflation gas source; and
coupling the inflation gas source with the aerostat envelope.

34. The method of claim 33 comprising coupling the control module with a pressure sensor, the pressure sensor configured to measure a pressure within the aerostat envelope.

35. The method of claim 34 comprising coupling the control module with at least one brake, and the at least one brake is coupled with at least one of the fore or aft envelope housing.

36. A method for controlling deployment of an aerostat envelope comprising:
inflating an aerostat envelope with an inflation gas source;
measuring a pressure in the aerostat envelope after initiation of inflation;
releasing a folded aft portion of the aerostat envelope for inflation if the measured pressure is at or above an envelope releasing threshold pressure; and
releasing a folded fore portion of the aerostat envelope for inflation if the measured pressure is at or above the envelope releasing threshold pressure after releasing of the folded aft portion.

37. The method of claim 36, wherein measuring the pressure in the aerostat envelope includes measuring the pressure with at least one pressure sensor within the aerostat envelope.

38. The method of claim 36, wherein releasing the folded aft portion includes rotating a first spindle through operation of at least one brake associated with the first spindle, the folded aft portion wrapped around the first spindle.

39. The method of claim 36, wherein releasing the folded fore portion includes rotating a second spindle through operation of at least one brake associated with the second spindle, the folded fore portion wrapped around the second spindle.

40. The method of claim 36 comprising interrupting release of one or more of the folded aft or fore portions if the measured pressure is at or below an interrupting threshold pressure.

41. The method of claim 36 comprising disconnecting a gas tubing coupling from the aerostat envelope if the measured pressure is at or above the envelope releasing threshold pressure after releasing of the folded fore portion.

42. The method of claim 36 wherein one or more of releasing the folded aft or fore portions of the aerostat envelope includes a programmable logic controller controlling the release of one or more of the folded aft or fore portions.
